(19) United States
(12) Patent Application Publication
(10) Pub. No.: US 2023/0259839 A1
(43) Pub. Date: Aug. 17, 2023

(54) SYSTEM FOR WORKFLOW MANAGEMENT

(71) Applicant: KYOCERA DOCUMENT SOLUTIONS INC., Osaka (JP)

(72) Inventors: Manuel Aralar MANALO, Fort Lee, NJ (US); Rajhdeep Jandir PABLA, Suisun City, CA (US); Jeremy Ryan LEE, San Jose, CA (US)

(73) Assignee: KYOCERA DOCUMENT SOLUTIONS INC., OSAKA (JP)

(21) Appl. No.: 17/672,372

(22) Filed: Feb. 15, 2022

(51) Int. Cl. G06Q 10/06; G06Q 10/10

(52) U.S. Cl. CPC G06Q 10/063114; G06Q 10/0633; G06Q 10/103

(57) ABSTRACT

A system for workflow progress analysis. The system includes a workflow management computing device for generating workflows including multiple events. The events may be actions to be taken, feedback to be given, approval of work product, and other stages of a workflow lifecycle. The workflow management computing devices may assign different events of a workflow process to one or more users or groups of users within an organization. Event assignment messages are transmitted to each user to which an event is assigned. Progress toward event completion is tracked and logged within the workflow management system. A variety of analytics may then be generated pertaining to one or more events of a workflow process.

### FIELD OF INVENTION

The technical subject matter of this application relates generally to the field of workflow management. Specifically, the claimed subject matter relates to detecting and classifying problems in electronic workflows within a workflow management system.

### BACKGROUND

Systems have been created to monitor progress toward workplace goals through the tracking of task or activity execution. Electronic workflow management systems enable the creation of workflow objects that include the various activities and tasks required in order to achieve a goal. Workflow management systems are implemented within organizations to track progress toward goals such as product development, software patch production, business change management, technical documentation production, and more. Any goal may require a number of tasks to be accomplished by one or more users, or groups of users, in order for the goal to be successfully completed. Tracking completion of these tasks and activities may provide managers and administrators with a snapshot of how much work has been done in furtherance of a goal. As workflows continue to increase in complexity, offering ever increasing numbers of required tasks, identifying and classifying issues within a workflow may enable organizations to more quickly adjust to project needs, or correct off-track projects.

### SUMMARY

Various embodiments are directed to a system for workflow progress analysis. The analysis of workflow events to identify patterns and statistics related to event completion may enable the identification of tasks, files, processes, and users that reduce the speed of workflow process completion.

One embodiment of the invention is a workflow management computing device including a processor, a display, a network communication interface, and a computer readable medium, coupled to the processor, the computer-readable medium comprising code, executable by the processor. The code may cause the processor to implement the steps of generating, in a data storage, a workflow process including a plurality of events; and assigning each of the plurality of events to one or more users of a user population. The workflow management computing device then transmits, via the network communication interface, to computing devices of each of the one or more users, event assignment messages indicating an event to which the user is assigned. Upon event completion, the workflow management computing device may receive, via the network communication interface, an event completion message from a computing device of a first user, indicating that an event assigned to the first user has been completed, wherein the event completion message includes event attributes for the completed event. The steps implemented by the workflow management computing device further include update, in a data storage, the event attributes for the completed event associated with the received event completion message. Further, the workflow management computing device generates, based on the stored event attributes, workflow progress analytics; and generates one or more graphical representations of the workflow progress analytics for the workflow process. The workflow management computing device may be display, via a graphical user interface on the display, the one or more graphical representations of the workflow progress analytics.

Additional embodiments include methods and processor-executable code stored on non-transitory computer-readable media for workflow progress analysis. Systems for implementing the same are also contemplated as embodiments.

Additional details regarding the specific implementation of these embodiments can be found in the Detailed Description and the Figures.

### BRIEF DESCRIPTION OF THE DRAWINGS

FIG. 1 shows a block diagram of a network environment suitable for implementing a workflow management system according to various embodiments.

FIG. 2 shows a block diagram of a workflow management computing device according to various embodiments.

FIG. 3 shows a block diagram of a user computing according to various embodiments.

FIG. 4 shows a block diagram of a workflow management graphical user interface according to various embodiments.

FIG. 5 shows a block diagram depicting workflow tracking graphical user interface according to various embodiments.

FIG. 6 shows a block diagram of a workflow progress analytics visualization graphical user interface according to various embodiments.

FIG. 7 shows a call flow diagram illustrating an exemplary workflow progress analytics generation and visualization according to an embodiment.

FIG. 8 shows a call flow diagram illustrating an exemplary workflow process completion according to an embodiment.

FIG. 9 shows a process flow diagram illustrating an exemplary method for producing workflow progress analytics according to an embodiment.

FIG. 10 shows a process flow diagram illustrating an exemplary method for event completion detection by a workflow management computing device according to an embodiment.

FIG. 11 shows a block diagram of a workflow progress analytics generation and visualization graphical user interface for a user computing device according to various embodiments.

FIG. 12 shows a call flow diagram illustrating an exemplary workflow progress analytics generation and visualization by a user computing device according to an embodiment.

FIG. 13 shows a call flow diagram illustrating an exemplary workflow progress analytics visualization by a user computing device according to an embodiment.

FIG. 14 shows a process flow diagram illustrating an exemplary method for visualizing workflow progress analytics on a user computing device according to an embodiment.

FIG. 15 shows a process flow diagram illustrating an exemplary method for detecting event completion according to an embodiment.

### DETAILED DESCRIPTION

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

Prior to discussing embodiments of the invention, some terms can be described in further detail.

A “workflow management computing device” may be a computing device or group of connected computing devices that executes an application for workflow process assignment and activity tracking. A workflow management computing device may generate workflow processes comprised of multiple events and assign those events to various users within an organization. The workflow management computing device may maintain one or more data stores of workflow processes, component events, and user assignments. Analytics and statistics related to the events of a workflow process may be calculated, generated, and visualized by the workflow management computing device. This device may be a server, servers, workstations, personal computers (PC), tablets, and the like, or a connected combination thereof.

A “user computing device” may be any suitable computing device that can interact with a user. User computing devices may be in any suitable form. Some examples of user computing devices include cellular phones, PDAs, personal computers, tablet computers, workstations and the like.

A “display” may be any electronic output device that displays or renders data in a pictorial or textual format. Displays may include computing device monitors, touchscreen displays, projectors, and the like.

A “graphical user interface” may be an electronic means of providing a visual way to interact with a computing device using items such as windows, icons, and menus.

A “network communication interface” may be an electrical component that enables communication between two computing devices. A network communication interface may enable communications according to one or more standards such as 802.11, BlueTooth, GPRS, GSM, 3G, 4G, 5G, Ethernet, or the lie. The network communications interface may perform signal modulation/demodulation. The network communications interface may include digital signal processing (DSP). Some embodiments may include computing devices that include multiple communications interfaces to enable communications according to different protocols or standards.

A “workflow process” may refer to a sequence of events involving the movement of data, such as tasks for processing data. Any passing of data or information between users or systems within an organization may be a workflow. A workflow process may be the process by which a workflow is accomplished. That is, a workflow process may be the events that must be accomplished to bring a workflow from unstarted to completion. A workflow process may encompass the data, forms, reports, and notifications required to get an electronic document from start to finish in a structured environment. This may include process workflows, case workflows, and project workflows.

An “event” may be a piece of work or an activity required in order to bring a workflow to completion. Events may be actions, approvals, feedback, or review. Events are associated with the movement of or changes in data within an organization. As an example, an event may be the modification of a shared text document, feedback on an update to an internal website, submission of files via a portal, review of submitted electronic documents, and the like.

An “Electronic message” refers to an electronic message for self-contained digital communication that is designed to be transmitted between physical computing devices. Electronic messages include, but are not limited to transmission control protocol (TOP) messages, user datagram protocol (UDP) message, electronic mail, a text message, an instant message, transmit data, or a command or request to access an Internet site.

An “event assignment message” may refer to an electronic message indicating an event of a workflow process and a target user to which the event is assigned. The event assignment message may be transmitted by a workflow management computing device to one or more user computing devices. If the user to which an event is assigned is a group, such as an information technology (IT) support team, then the message may be transmitted to multiple recipients, including the members of the IT support team. The event assignment message may include an event identifier, mapping to an event maintained in a data storage of the workflow management computing device. The event notification message may contain user identifiers for one or more users to which the event is assigned. The event assignment message may include event completion information such as timeline, goals, deliverables, and links to relevant data files needed to complete the event. The event assignment message may also include information about other users to which the event is assigned, the next event in a workflow process, or any other information useful in completing the vent.

An “event completion message” may refer to an electronic message indicating completion of a particular event of a workflow process. The event completion message may be transited by a user computing device to a workflow management computing device to signal the completion of the event to which the user was assigned. The event completion message may optionally be transmitted to the user computing devices of other users associated with the event. For example, if an event is assigned to a research and development team, and an engineer competes the event, the event completion message may be transmitted to the rest of the research and development team to inform them that the event is complete. As an alternative, the workflow management computing device that receives the event completion message may forward it to other associated users. This may allow for informing of users associated with the event in the workflow management computing device data storage, but unknown to the user computing device that transmitted the event completion message. The event completion message may include one or more event attributes such as an event identifier, one or more user identifiers for users to which the event was assigned, a completion time, links to data files associated with the completion of the event, etc.

An event “rejection message” may refer to an electronic message indicating that a user to whom an event has been assigned, rejects the event assignment. For example, a user computing device may transmit an event rejection message after a user provides input that the user does not wish to assume responsibility for an assigned event, or that the event has been assigned erroneously. This input may be provide via an input device of the user computing device. Alternatively, the expiration of an acceptance timer may trigger the transmission of an event rejection message. The event rejection message may include an event identifier, a target user (e.g., user identifier), and optionally a rejection code indicating a reason that the event was rejected. Rejection codes may include response time out, assignment error, user not found, user refusal, etc.

“Event attributes” may refer to characteristics, fields, attributes, or settings of one or more events of a workflow process. For example, event attributes may include beginning and ending timestamps, time actually spent on an event, files access during an event, files modified during event completion, users who worked on the event, network addresses of computing devices that worked on or opened files associated with the event, comments regarding event completion, and the like. Event attributes may be included in event completion messages to enable collection and analysis by the workflow management computing device.

“Workflow progress analytics” may refer to the results of performing one or more data analysis processes on the event attributes. Workflow progress analytics may be generated during or after completion of a workflow process. That is, workflow progress analytics may be generated for one or more events of a workflow process in order to gain insights into the current status of a project; or the workflow progress analytics may be generated at the end of workflow process completion to obtain information about the nature of workflow process completion. In various embodiments, the workflow progress analytics are generated by the workflow management computing device. Various data analytics techniques and software packages may be used to generate the workflow progress analytics. Examples of workflow progress analytics may include analytics for a user to which an event of the workflow process is assigned, and wherein the workflow progress analytics for the user include one or more of a number of events assigned to the user, completion time for each event assigned to the user, and a number of electronic documents modified by the user during completion of each event assigned to the user. In another example, workflow progress analytics include analytics for an event of the workflow process, and wherein the workflow progress analytics for the event include one or more of the completion time of the event, number of users assigned to the event, and electronic documents accessed in completion of the event. Further, workflow progress analytics may include one or more of the completion time for the entire workflow process, an original estimated completion time for the workflow process, a workflow process manager, use of templates in completion of events of the workflow process, modification of electronic documents during completion of the workflow process, number of events that required user approval, number of events that required user action, number of users that have read-only permission for events of the workflow process, number of events requiring feedback, number of users assigned to feedback events, whether an electronic document was replaced during completion of the workflow process, addition of file attachments during completion of the workflow process, and whether there was use of a parallel workflow process. The workflow progress analytics may also include one or more of which events were rejected, whether any rejected events were forwarded to other users.

A “user” may include an individual or a computational device. In some embodiments, a user may be associated with one or more individual user accounts and/or mobile devices or personal computing devices. In some embodiments, the user may be an employee, contractor, or other person having authorized access to make use of a networked computing environment. In other embodiments, the user may be a group of employees, contractors, or other personnel such as a product development team, a department, or division of an organization.

A “server computing device” is typically a powerful computer or cluster of computers. For example, the server computer can be a large mainframe, a minicomputer cluster, or a group of servers functioning as a unit. In one example, the server computer may be a database server and may be coupled to a Web server. The server computing device may also be referred to as a server computer or server.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable computer-readable device or devices that can store electronic data. A suitable memory may comprise a non-transitory computer readable medium that stores instructions that can be executed by a processor to implement a desired method. Examples of memories may comprise one or more memory chips, disk drives, removable memory, etc. Such memories may operate using any suitable electrical, optical, and/or magnetic mode of operation.

Throughout the project lifecycle, any number of actions may need to be coordinated in order to ensure the efficient and timely completion of project benchmarks. For this reason, project workflows may be created to visualize and track the relationship between events need to complete a project benchmark. Workflows can enable members of a project team to track progress towards goals. This tracking capability can vastly improve goal progress efficiency in organizations where projects involve cross-functional team participation or participation by members of groups with different operating functions. For example, workflows that may involve cross-functional team participation include but are not limited to research and development systems, knowledge management systems, ordering and fulfillment logistics systems, operations systems, accounting systems, marketing systems, and more.

However, the more complicated a system, the more complicated its associated workflows are likely to be, creating opportunities for breakdowns or “log jams” that slow progress. Complexity may arise from the nature of the work itself, the number of business units involved in completing the workflow, checkpoints or feedback required during the process, materials sourcing, and simply the everyday functioning of individual units responsible for work. Any of these factors may require their own sub-workflow processes to track progress toward a milestone needed to complete the greater workflow goals. This type of granular progress tracking may be necessary in order to optimize cross-functional participation and integrate event achievement across systems.

One reason for added workflow complexity relates to file and data handling across systems or teams. Data and files required for event completion may be siloed within a different business unit, team, or organizational system. While files and data may be moved across systems to enable access to users throughout an organization, ensuring that all necessary users have adequate permissions to access files and documents required for workflow goal completion may be difficult. Further, data and file version and modification tracking may be difficult to maintain as data and files move across separate units a, teams and systems. As data and files are accessed and modified by various participants in a workflow, it may be challenging to determine which users accessed and modified which files and when that modification was performed. Performing an analysis of workflow progress during various stages of workflow completion or at the culmination of a workflow, may assist administrators in identifying breakdowns in workflow.

The various embodiments provide solutions for the above-referenced challenges using data analytics and visualization. By enabling the identification and visualization of workflow process chokepoints, such as file handling and versioning difficulties, and user data handling inefficiencies, the various embodiments may improve scalability, timeliness of workflow completion, and efficiency of goal completion. By monitoring and analyzing data related to workflow completion by various organizational participants. The various embodiments disclose methods for maintaining data about the most current status, version, and modification of data, files, and event completion throughout stages of a workflow process. This information is collected from all workflow contributors across organizational units and systems, and is maintained by a workflow management computing device. In this way, a workflow management computing device can monitor and analyze workflow progress across all organizational units and systems, regardless of original ownership of data, files, materials, or applications used in workflow completion. The results of workflow progress analysis may be used to generate visualizations illustrating characteristics of workflow completion as it applies to participants. Various data visualization modes may be used to provide customizable visualization experiences for users of different teams, units, or systems.

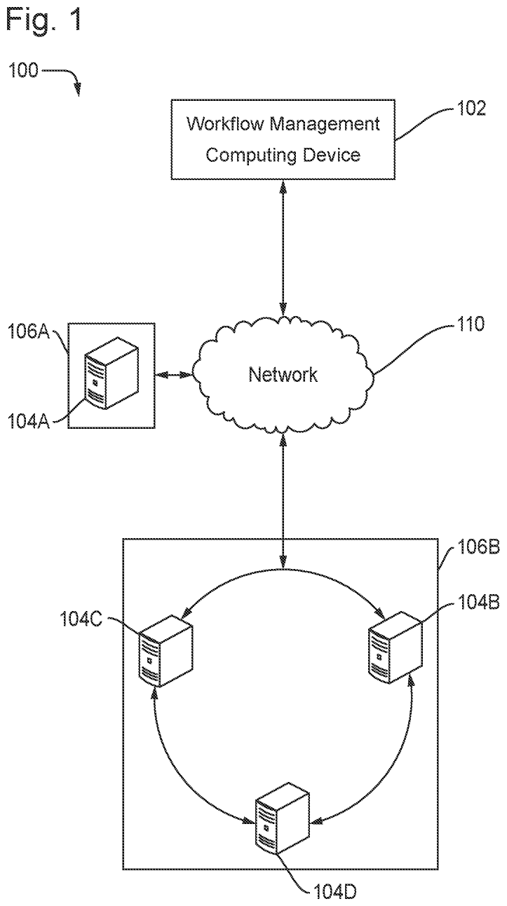

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

FIG. 1 illustrates an exemplary system 100 for workflow management and analysis according to various embodiments. With reference to FIG. 1, a workflow management system 100 may generate workflows requiring participation by any number of users 106A, 106B including users of different groups, teams, business units, and organizational systems. Data related to the completion of events may be aggregated by a workflow management computing device 102 for analysis and visualization. This data may be stored in a data store accessible by the workflow management computing device 102. Analytics may be run on the data stored in the data store to produce workflow progress analytics, which may be stored in the data store or exported to various systems within the broader Organization, or externally as needed. Workflow management applications running on the workflow management computing device 102 or visualization applications running on one or more user computing devices 104 A-D may use the workflow progress analytics to generate visualizations illustrating characteristics of workflow processes.

An organization may include any number of users 106, 1068, some of whom may operate in different business units, teams, or levels of the organizational structure. Each of these organizational units may have associated network infrastructure and computing systems. For example separate computing systems may exist for research and development departments, procurement, accounting, shipping and distribution systems, and other organizational units. These computing systems may have associated software, computing devices, machinery, data stores, and network infrastructure specific to the needs of the business unit. Data in varying formats is generated during the operation of each of these computing systems, and may be collected, managed and stored for use in carrying out the functions of the business unit with which it is associated.

The system 100 may be a part of a broader organizational computing environment and may connect a workflow management computing device 102 to various computing systems throughout the Organization via a network 110. The system 100 can include any suitable network infrastructure including servers, data stores (i.e., databases), computing devices, mobile communication devices, etc. Data generated by other computing systems of the Organization may be transferred and, or transmitted to the workflow management computing device 102 by one or more infrastructure components. As illustrated in FIG. 1, user computing devices 104A and 104B-D, which may be associated with different organizational units, may transmit data related to event scheduling and completion, file access, and more to the workflow management computing device 102 via the network 110.

The workflow management computing device 102 includes a combination of software, data storage, and processing hardware that enable it to operate as the central workflow generation, management, and tracking engine for the system 100. Data is transmitted by user computing devices 104A-D over network 110 for collection and aggregation by workflow management computing device 102, which may organize and store the data in a data store. As users 106A, 1068 within cross-functional Organizational units provide additional data, the workflow management computing device 102 integrates this data into the data store and updates the status of various events of stored workflow processes. User computing devices 104A-D may access workflow process completion status information by transmitting requests to the workflow management computing device over the network 110. Such requests may be used to initiate generation of workflow progress analytics and transmission of the same to a user computing device 104A-D for visualization rendering.

The data store may be any suitable data storage in operative communication with the workflow management computing device 102. For example, the data store may be stored in a memory of the workflow management computing device 102 or in one or more external databases. Location of the data store within system 100 is fungible, such that the data store may sit within any system of the Organization, so long as it is in communication with workflow management computing device 102. The data store may retain data generated, modified, or otherwise published by various systems of the Organization as part of workflow process completion. The data store may also store models, analysis scripts, or other frequently used software code used to perform analysis of the stored data.

The workflow management computing device 102 may employ multiple software models including programming code instructing a processor of the workflow management computing device to analyze data received from the various systems of the Organization. A number of models may be pre-loaded or pre-configured as part of a software application executing on the workflow management computing device 102, to enable quick analysis of workflow process data. Administrators may access model selection and perform data analysis via a workflow management application. Using the workflow management application, Administrators may create templates or scripts including frequently used analysis models for execution. Similarly, templates or scripts of frequently used models may be pre-installed or preconfigured on the workflow management computing device 102. Executing data analysis using the templates or scripts may cause the processor of the workflow management computing device 102 to execute several analysis models in the same processing session without additional instructions from an administrator.

Workflow processes generated by the workflow management computing device 102 are data objects composed of multiple event objects, each associated with a physical or logical components. A workflow process may be linear or hierarchical in structure. For example, a linear workflow process may be represented by a markov chain queue in which event must be completed before the next event can be initiated or completed. Conversely, hierarchical workflow processes may include events that can be completed in parallel and as such, may be represented by a tree structure. The workflow management computing device can generate workflow processes via the workflow management application by selecting or entering events along with the event's association with physical or logical components and the event's relationship to other events of the workflow process. The workflow process object may be generated as a corresponding data structure once all related events are added. Workflow data structures may be stored in the data store. Similarly, a link to the starting node of the workflow process's data structure may be stored in the data store as part of a database for tracking active workflow processes.

Events of a workflow process are assigned by the workflow management computing device 102 to one or more users. These users may be individuals such as the personnel operating user computing device 104A, or groups of personnel such as those operating user computing devices 104B-D. The workflow management computing device 102 communicates event assignments to users via network 110 and may track completion of events throughout the workflow process lifecycle. Event assignments may be stored in the data store in association with each event. The storage of event assignments and the event objects themselves may be maintained in the data store for a given period of time, which may vary according to the nature of the event object or the associated physical and logical components. To promote timely completion of events and accuracy of event completion record-keeping, the workflow management computing device may query user computing devices 104A-D to obtain the status of events dented as incomplete in the data store. Such queries may occur upon administrator demand, or at regular intervals, or after expiration of a pre-determined wait period.

Personnel operating user computing devices 104A-D complete events assigned to them personally or to their user group. During completion of an event, physical and, or logical components are accessed by personnel to take required action. For example, events may require the generation of files, modification of files, generation of structured or unstructured data, modification of structured or unstructured data, analysis of structured or unstructured data, analysis or testing of a physical device, modification or upgrading of a physical device, updating software versioning on a device, reviewing the actions taken to complete prior events, authorizing event completion or initiation by other personnel, and the like. The process of completing events is characterized by various event attributes, which may indicate or be descriptive of the time, place. And manner of work towards event completion. These event attributes are tracked and, or collected by a workflow application of a user computing device 104A engaged in completing an event. The specific attributes collected and their format may differ across computing systems of the Organization. Regardless of source systems, the workflow management computing device 102 receives event attributes from various user computing devices 104A-D as events are completed, then cleans, normalizes, are transforms event attribute data as needed to create common data formatting and improve the ease of analysis.

Applying one or more of the analysis models to the event attributes results in the generation of workflow progress analytics. Workflow progress analytics characterize a data set and may describe or indicate trends in data over a given period of time, across a population, across geographical locations, and, or across systems of the Organization. These workflow progress analytics may be generated automatically at regular intervals, upon completion of a threshold number of events, upon workflow process completion, or on-demand by administrators or authorized personnel. Once generated, workflow progress analytics may be stored in the data store in association with a workflow process. Frequently used analysis results, such as those resulting from execution of an analysis model template or script may be stored in a database in association with the workflow process. For example, an identifier of the workflow process maybe assigned during generation and all frequently used analysis results may be stored in database fields associated with the workflow process identifier. Reports or summaries of workflow progress analytics may be generated by the workflow management application of the workflow management computing device 102 and transmitted to any requesting parties, or stored in the data store for later use.

The workflow progress analytics may represent performance trends for one or more events of a workflow process. For example, the average number of hours required to propagate firmware updates across all printing devices within an Organization may be a workflow progress analytic indicative of event performance trends. The workflow progress analytics can include expressions such as deviation, percentages, sums, and aggregates. Workflow progress analytics are not limited to a single workflow process. While workflow progress analytics may be generated for events of a single workflow process, as may be useful in gauging user participation in a protracted workflow process, it may be necessary for some types of workflow progress analytics that analysis be performed across events and, or workflow processes. As an example, the number of personnel members that access a data set prior to completion of a type of event, regardless of user group or computing system, may require analysis of event completion information (e.g., event attributes) for that type of event across many workflow processes. As such, workflow progress analytics may be generated in a granular fashion for individual workflow processes and their respective events, or for sub-portions of the entire population of workflow processes and events.

Workflow progress analytics generated by applying one or more analysis models to the collected event attributes can be used to generate graphical representations of data characteristics. Data visualizations may be generated by the workflow management computing device 102 or by the user computing devices 104A-D according to permissions grants. Both client and administrator versions of workflow applications may enable the analysis and visualization of housed in the data store. However, some users may have restricted access to the workflow data that can be accessed. This enables the generation of graphics and reports relevant to users. As with the analysis models, there may be customizable or preconfigured templates for data visualization to reduce the time and computing resources needed to generate regularly used graphics. Once generated by either the workflow management computing device 102 or a user computing device 104A, visualizations may be output for display, captured in a file and stored in the data store or elsewhere in the system 100, or transmitted across the network 110 to other users.

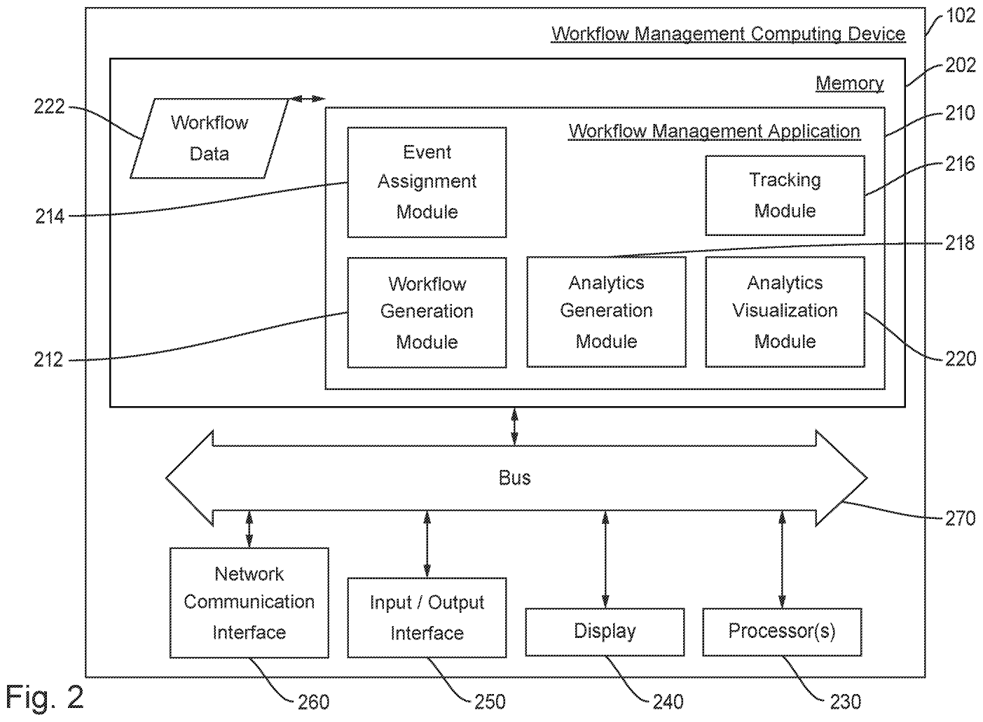

Referring now to FIG. 2, there is shown an example of a computer system within which a set of instructions, for causing the computing system to perform any one or more of the methods discussed herein, may be executed. With reference to FIGS. 1-2, the computer system may correspond to the workflow management computing device 102 of FIG. 1. The workflow management computing device 102 may support the generation, tracking, and analysis of workflows throughout cross-functional units of an Organization. In some implementations, the various software modules and data structures stored in and executed by workflow management computing device 102 may be distributed across two or more connected computing devices a workstation and one or more servers.

The workflow management computing device 102 may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware of the virtualized data center. For example, the VM may operate based on computer architecture and functions of computer hardware resources associated with hard disks or other such memory. The VM may emulate a physical computing environment, but requests for a hard disk or memory may be managed by a virtualization layer of a host machine to translate these requests to the underlying physical computing hardware resources. This type of virtualization results in multiple VMs sharing physical resources.

In certain implementations, the workflow management computing device 102 may be connected (e.g., via a network, such as a Local Area Network (LAN), an intranet, an extranet, or the Internet) to other computer systems. The workflow management computing device 102 may operate in the capacity of a server or a client computer in a client-server environment, or as a peer computer in a peer-to-peer or distributed network environment. Workflow management computing device 102 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein for supporting micro-services of a workflow management system.

The workflow management computing device 102 includes a processing device such as a processor(s) 230, a memory 202 which includes multiples: a main memory (e.g., read-only memory (ROM), flash memory, dynamic random access memory (DRAM) (such as synchronous DRAM (SDRAM) or DRAM (RDRAM), etc.) and a static memory (e.g., flash memory; a static random access memory (SRAM), etc.), and a data storage device (e.g. data store), which communicate with each other via a bus 270.

Processor 230 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processor 230 may also be one or more special-purpose processing devices such as an application specific integrated circuit (ASIC), a field programmable gate array (FPGA), a digital signal processor (DSP), network processor, or the like. The processor 230 is configured to execute processing logic for performing the operations and steps discussed herein.

The workflow management computing device 102 may further include a network communication interface 260 communicably coupled to a network 110. The workflow management computing device 102 also may include a video display unit such as display 240 (e.g., a liquid crystal display (LCD) or a cathode ray tube (CRT)), an input/output interface 250 including an alphanumeric input device (e.g., a keyboard) and, or a cursor control device (e.g., a mouse), and an optional signal generation device (e.g., a speaker).

The memory 202 may include a computer-readable storage medium (e.g., a non-transitory computer-readable storage medium) on which may store instructions encoding any one or more of the methods or functions described herein, including instructions encoding a workflow management application 210 for implementing methods for supporting the generation, management, analysis, and visualization of workflow progress may also reside, completely or partially, within volatile memory and/or within processor(s) 230 during execution thereof by workflow management computing device 102, hence, volatile memory of memory 202 and processor device 230 may also constitute machine-readable storage media.

The non-transitory machine-readable storage medium may also be used to store instructions to implement a workflow management application 210 for supporting the generation, management, analysis, and visualization of workflow progress in a cloud-based system, and/or a software library containing methods that call the above applications. While the machine-accessible storage medium is shown in an example implementation to be a single medium included within memory 202, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the disclosure. The term “machine-accessible storage medium” shall accordingly be taken to include, but not be limited to, solid-state memories, and optical and magnetic media.

Regardless of implementation of the computer-readable storage medium, the workflow management application 210 may contain one or more modules of processor-executable instructions for performing various routines and sub-routines of the methods described herein. For example, the workflow management application 210 may include a workflow generation module 212 of instructions for executing the collection of data related to new workflow processes, the generation of those workflow processes, and the generation of corresponding data structures, data structure nodes, or data structure entries associated with the new workflow processes which may be stored as part of workflow data 222. The workflow management application 210 may also include an event assignment module 214 including instructions for assigning events to users and generating, transmitting, and receiving messages indicating assignment of events of a workflow process to a user 106A-B. The event assignment module 214 may also update the workflow data 222 to include user 106A-B assignments for events of a workflow process. The workflow management application 210 may include a tracking module 216 of instructions for monitoring event completion by users 106A-B.

The workflow management application 210 may also include modules of processor-executable instructions for performing operations related to the generation and visualization of data analytics from the workflow data 222. The analytics generation module 218 may include instructions for passing workflow data 222 to one or more data analysis models to obtain workflow progress analytics. The instructions of analytics generation module 218 may include scripts, instruction templates, and other pre-determined code segments for analyzing data in frequently used sequences. The workflow management application 210 may include an analytics visualization module 220 for generating charts, graphs, and other visualizations characterizing the workflow progress analytics generated by the analytics generation module 218. Visualizations generated by the analytics visualization module 220 include instructions for enabling the processor(s) 230 to render the visualization(s) on display 240.

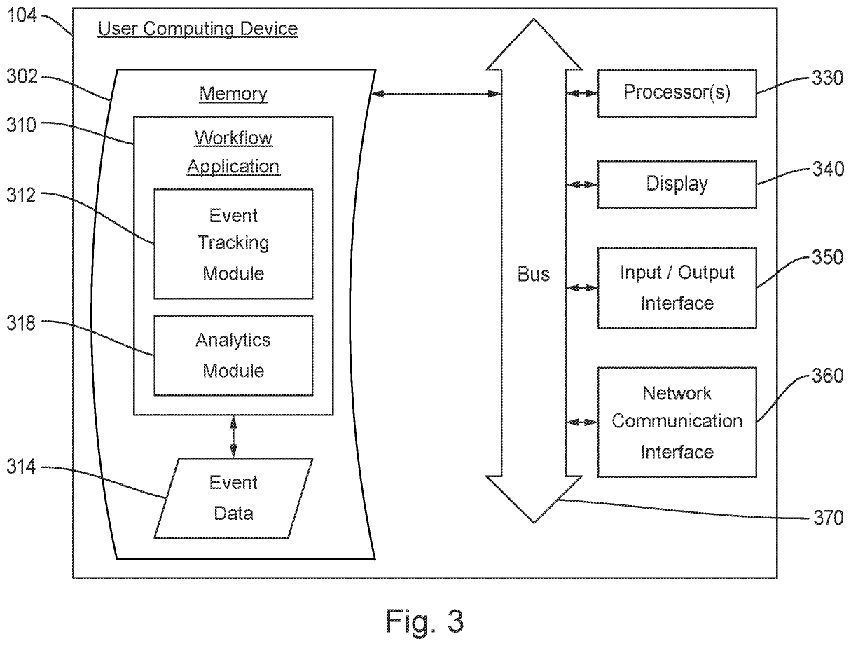

Referring now to FIG. 3, there is shown an example of a user computing device 104 within which a set of instructions, for causing the computing system to perform any one or more of the methods discussed herein, may be executed. With reference to FIGS. 1-3, the user computing device 104 may correspond to any of the user computing devices 104 A-D of FIG. 1. In some implementations, the user computing device 104 may enable users within cross-functional units of the Organization to complete and report events of a workflow process to which they are assigned.

In certain implementations, the user computing device 104 may be connected (e.g., via a network, such as a Local Area Network (LAN), an intranet, an extranet, or the Internet) to other computer systems. The user computing device 104 may operate in the capacity of server or a client computer in a client-server environment, or as a peer computer in a peer-to-peer or distributed network environment. User computing device 104 may be provided by a personal computer (PC), a tablet PC, a set-top box (STB), a Personal Digital Assistant (PDA), a cellular telephone, a web appliance, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein for completing events of a workflow process.

The user computing device 104 includes a processing device such as a processor(s) 330, a memory 302 which includes multiples: a main memory (e.g., read-only memory (ROM), flash memory, dynamic random access memory (DRAM) (such as synchronous DRAM (SDRAM) or DRAM (RDRAM), etc.) and a static memory (e.g., flash memory; a static random access memory (SRAM), etc.), and a data storage device (e.g. data store), which communicate with each other via a bus 370.

Processor 330 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processor 330 may also be one or more special-purpose processing devices such as an application specific integrated circuit (ASIC), a field programmable gate array (FPGA), a digital signal processor (DSP), network processor, or the like. The processor 330 is configured to execute processing logic for performing the operations and steps discussed herein.

The user computing device 104 may further include a network communication interface 360 communicably coupled to a network 110. The user computing device 104 also may include a video display unit such as display 340 (e.g., a liquid crystal display (LCD) or a cathode ray tube (CRT)), an input/output interface 350 including an alphanumeric input device (e.g., a keyboard) and, or a cursor control device (e.g., a mouse), and an optional signal generation device (e.g., a speaker).

The memory 302 may include a computer-readable storage medium (e.g., a non-transitory computer-readable storage medium) on which may store instructions encoding any one or more of the methods or functions described herein, including instructions encoding a workflow application 310 for implementing methods for accepting workflow event assignments, monitoring event completion and workflow progress within a workflow with which a user is associated, and analysis, and visualization of workflow progress may also reside, completely or partially, within volatile memory and/or within processor(s) 330 during execution thereof by user computing device 104, hence, volatile memory of memory 302 and processor(s) 330 may also constitute machine-readable storage media.

The non-transitory machine-readable storage medium may also be used to store instructions to implement a workflow application 310 for supporting the accepting workflow event assignments, monitoring event completion and workflow progress within a workflow with which a user is associated, and analysis, and visualization of workflow progress in a cloud-based system, and/or a software library containing methods that call the above applications. While the machine-accessible storage medium is shown in an example implementation to be a single medium included within memory 302, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the disclosure. The term “machine-accessible storage medium” shall accordingly be taken to include, but not be limited to, solid-state memories, and optical and magnetic media.

The workflow application 310 may contain one or more modules of processor-executable instructions for performing various routines and sub-routines of the methods described herein. For example, the workflow application 310 may include an event tracking module 312 of instructions for executing the receiving and acceptance/rejection of events associated with a workflow process generated by the workflow management computing device 102. The event tracking module 312 may provide instructions for receiving event assignment messages, storing the event assignment information in the event data 314 and displaying the event assignment for user 106 approval. Approval or rejection of an event is indicated via user input to the input/output interface 350, which may receive signals associated with a user interaction and may pass these signals to the processor(s) 330. The event tracking module 312 accepts the processor(s) 330 interpretation of the signals as an acceptance, rejection, or other status for the event, and takes additional action according to instructions of the module.

Accepted assignments may be indicated as such in the event data 314, and updated as tasks associated with the event are completed. The event tracking module 312 may include instructions for rendering an event completion visualization such as a progress bar or the like for output to the display 340. Similar visualizations bay be generated and displayed for events assigned to other users but a part of the workflow process with which the accepted event is associated.

Rejection of event assignments, may cause the processor to render and output for display a selection screen indicating other users to whom the event can be assigned. Once a new user is assigned, the event tracking module 312 may generate a new event assignment message and transmit it to the new user 106 A-B via the network communication interface 360.

The event tracking module 312 may initiate the generation of acceptance and rejection messages, which may be transmitted to the workflow management computing device 102 via the network communication interface 360.

In certain embodiments, the user computing device 104 may also include an analytics module 318 similar to the analytics generation module 218 and the visualization module 220 described with reference to the workflow management application 210 of the workflow management computing device 102. For example, the analytics module 318 may include processor-executable instructions for performing operations related to the generation and visualization of data analytics from the event data 314 and workflow process information obtained from other users 106. The analytics module 318 may include instructions for using event data 314 and workflow process information as inputs to generate workflow progress analytics. The instructions of analytics module 318 may include scripts, instruction templates, and other pre-determined code segments for analyzing data in frequently used sequences. The analytics module 318 may also include processor-executable instructions for generating charts, graphs, and other visualizations characterizing the workflow progress analytics generated by the analytics generation module. Visualizations generated by the analytics module 318 may include instructions for enabling the processor(s) 330 to render the visualization(s) on display 340.

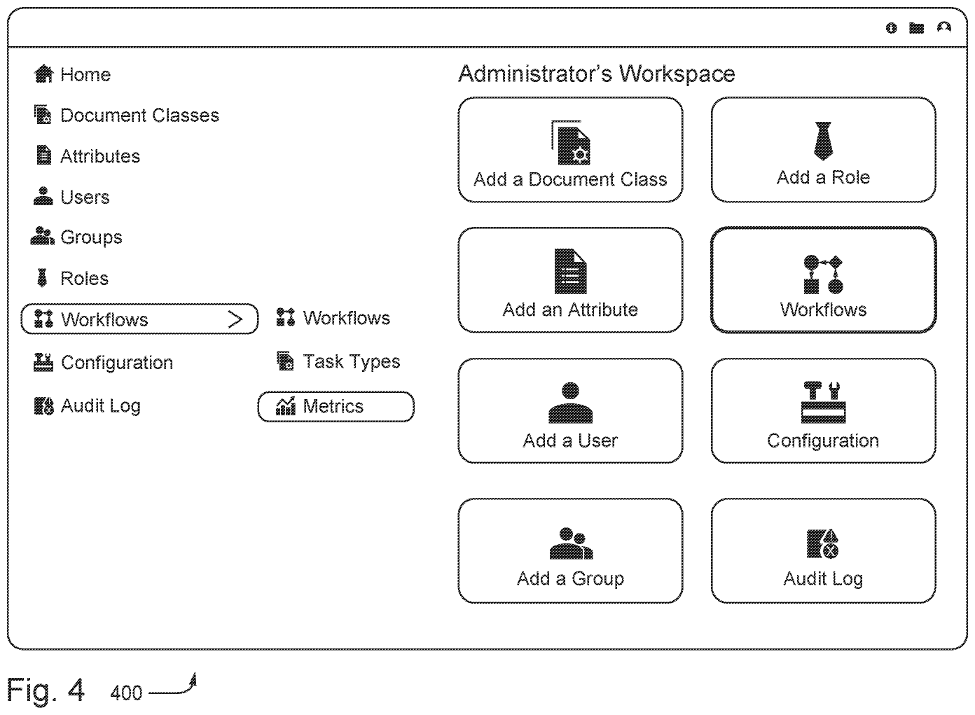

Referring now to FIGS. 4-6, example implementations of graphical user interfaces (GUIs) generated by executing the processor-executable instructions of the workflow management application 310 on the workflow management computing device 102. The illustrated graphical user interfaces are output for display on the display 240 and may feature one or more interactive on-screen elements. These elements are selected via the input/output interface 250. The positioning, naming, and visualization of elements within the graphical user interfaces are shown here for illustrative purposes. Various modifications may be made to enable the execution of the various methods described herein.

FIG. 4 shows an example workflow management GUI according to various embodiments. With reference to FIGS. 1-4, the workflow management computing device 102 executing the instructions of the workflow management application 210 may utilize one or more of the coding modules to render and output for display, an administrative GUI 400. An administrative GUI 400 may provide functionality enabling an administrator of the workflow management computing device 102 and, or the workflow management system 100, to generate new workflow processes, track completion of existing workflow processes, and generate workflow progress analytics and corresponding visualizations.

The administrative GUI 400 includes several visual element for managing workflows such as the various buttons illustrated in FIG. 4. These visual elements are displayed via the display 240 and may be selected using one or more of the input/output interfaces 250 to inform the processor(s) 230 that a GUI associated with the selected visual element should be output for display. That is, the selection of a visual element of a GUI may result in an instruction to utilize one or more of the modules of the workflow management application 210.

A “workflows” or similar visual element provides an administrator with access to current workflow processes as well as the ability to generate new workflow processes. This visual element can be a button, a menu tab, or the like. Selection of the visual element may instruct the processor(s) 230 to execute the instructions of one or more of the workflow generation module 212 event assignment module 214, tracking module 216, which may also be executed in association with other features of the workflow management application 210 and the administrative GUI 400. Such selection may cause new menu options to be displayed, or result in the display of an updated GUI, either providing functionality for monitoring and generating workflow processes. A workflow generation UI (not shown) provides a visual interface for creating new workflow processes and storing associated data structures in workflow data 222 of the memory 202. To generate a new workflow process, the administrator selects a workflow process template or selects to create a new workflow process from scratch. The name of the new workflow process, required events and their tasks, due dates, users, user groups, any relevant permission, and any other necessary information is input by the administrator. The instructions of the workflow generation module 212 executed by the processor(s) 230 may create a new data structure node and insert the provided information into various fields of the node. For example, if a workflow process contains multiple events that must occur in linear fashion, the workflow generation module may generate a linked list of events, each node of the linked list including an event, tasks of that event, and a user identifier for a user to which the event is assigned, along with any due date or require file information. Similarly, if a workflow process includes events that can or should be completed in parallel, the workflow generation module 212 may generate a tree data structure having a number of event nodes, in which the structure of the tree (i.e., the pointers between nodes) reflect the path of event completion. The workflow process is assigned a workflow identifier, which is stored in workflow data 222. A pointer to the first node of the workflow process data structure, along with an iteration pointer that points to the first node that has not been completed (i.e., the current task) may be stored in the workflow data 222 in association with the workflow identifier. Other data relating to the workflow process such as the number of events, generating user, number of users involved, etc. may be added to the workflow data 222. In some implementations, the workflow data 222 includes a database including workflow process identifiers and corresponding event attributes. The workflow data 222 may also include a database for tracking user assignments. For the purpose of providing a clear disclosure, these databases may be referred to collectively as “the database” and some information may be stored redundantly or may be held in either database according to the implementation. The workflow data 222 also includes any data structures representing workflow processes, their respective events, and attributes or characteristics of tasks and events off the workflow process as they are completed. Once generated, workflow processes can be viewed via the administrative GUI 400 or by accessing a separate GUI for workflow process tracking.

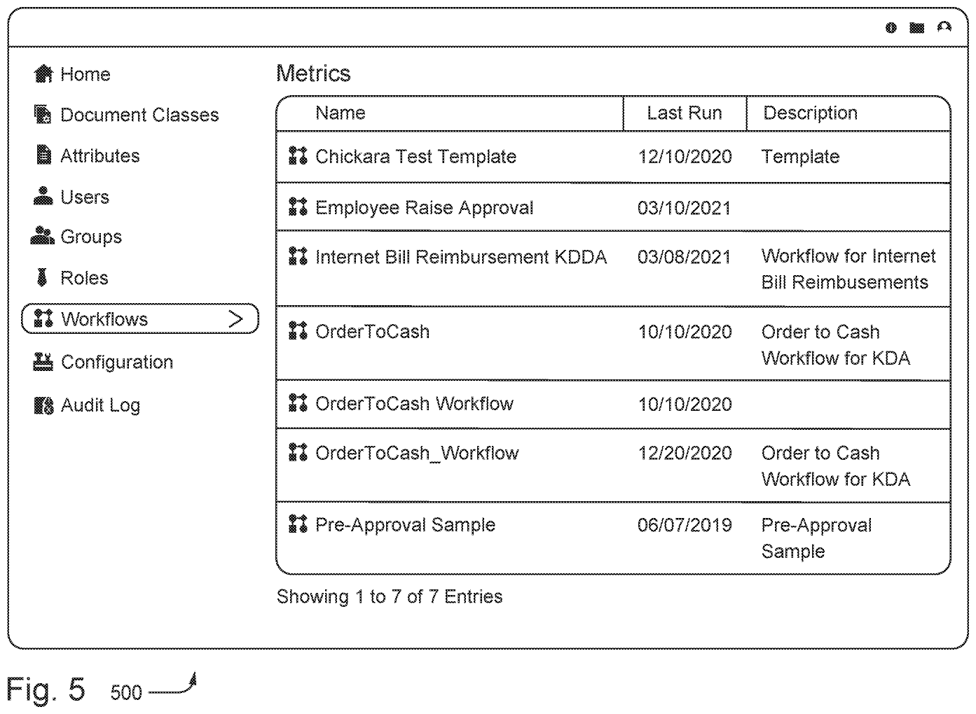

FIG. 5 shows a block diagram depicting a workflow tracking graphical user interface according to various embodiments. With reference to FIGS. 1-5, an updated GUI may include a workflow tracking GUI 500 produced by executing the workflow tracking module 215 of the workflow application 210. The workflow tracking GUI 500 includes one or more charts, tables, etc. displaying information stored in data structures of workflow data 222. The name of each workflow process, last update date, and a description of the type of workflow process provide an administrator with that current status of a particular workflow process. Additional information about the last completed event, user assignments, due dates, and the like, can also be displayed on the workflow tracking GUI 500. In some embodiments, administrators may customize the fields of workflow data 222 shown in the chart or table or workflow tracking GUI 500. Selection via the input/output interface 250 of a workflow process displayed in the chart or table results in the display of additional information about the workflow process, its events, the users to which the events are assigned, completion progress and the like.

The current status, or progress towards completion of a workflow process may be determined by the processor(s) 230 based at least in part on the information of workflow data 222. Each time am event assignment, events are accepted, or events are completed, is made, a database entry for that event may be updated to modify the status, the responsible user, and other attributes of the event. A pointe stored in the database may be updated to point to the node of a workflow process data structure including the first uncompleted event, (i.e., the current event). Information associated with the most current event, either in the data structure node or the database, may be displayed as part of a current status for the workflow process. The number of events completed, number of events left to be completed, responsible users, completion times, and due dates, may also be displayed via the workflow tracking GUI 500.

As events or a workflow are completed, a client application, i.e., workflow application 310 operating on a user computing device 104 that completed the event transmits an event completion message to the workflow management computing device 102. Event completion messages are received via the network communication interface 260 and passed to the processor(s) 230, which executes the tracking module 216 to update workflow data 222 with regard to the completed event. The event completion messages may contain one or more event attributes, data that is descriptive of, or generated by the completion of the event. These event attributes are added to the workflow data 222 such as in database entries, and, or nodes of a workflow process data structure to which the event belongs. As events are completed, sufficient data may be aggregated to enable the application of analytics models to the workflow data 222. The outcome of these analytics models is workflow progress analytics, which may be viewed as numeric metrics or as visualizations.

The processor(s) 230 may execute instructions of tracking module 216 and, or analytics generation module 218 to implement the functionality of the workflow tracking GUI 500. To view workflow progress analytics for workflow processes individually or groups of workflow processes, the administrator may access a workflow progress analytics GUI.

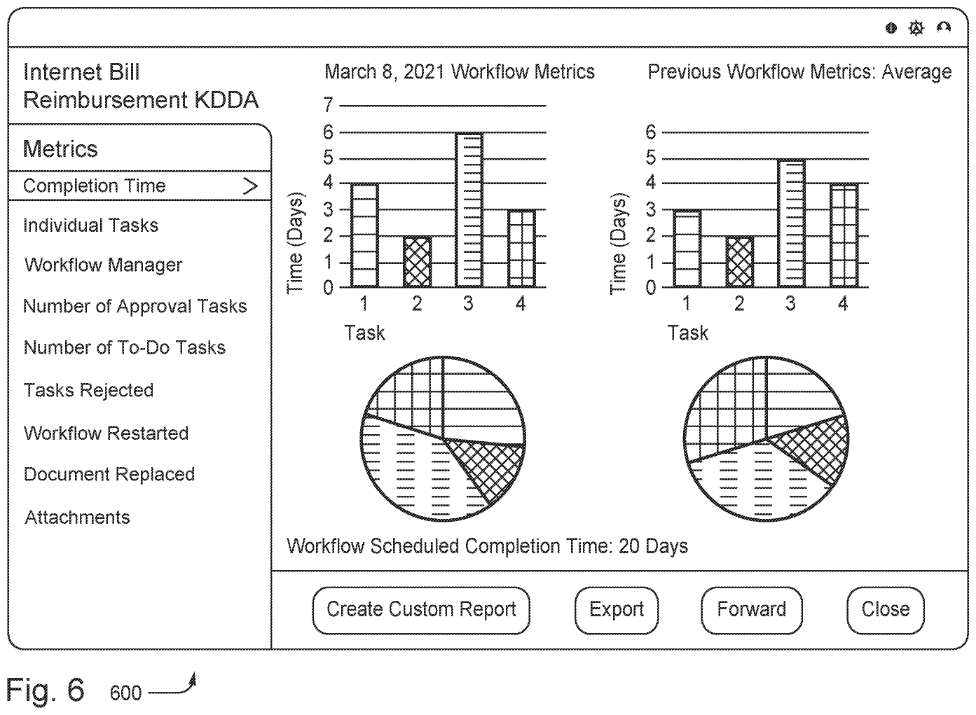

FIG. 6 shows a block diagram of a workflow progress analytics visualization graphical user interface according to various embodiments. With reference to FIGS. 1-6, a workflow progress analytics visualization GUI may be represented by visualization GUI 600, which provides functionality for generating displayed visualizations of workflow progress analytics. Various graphs, charts, models, or other visualizations may be generated based on the information in workflow data 222.

The visualization GUI 600 illustrates how metrics may be generated and visualized for a workflow process entitled “Internet Bill Reimbursement DDA.” The graphs show the average number of days needed to compete tasks associated with events of the workflow process type in the month of March and the previous months' averaged. The pie charts at the bottom of visualization UI 600 show the portion of time needed to complete the tasks associated with workflow process events over the same time periods as the charts. This set of visualizations provides an administrator or user with information about how long tasks generally take to complete and how the current completion time compares to historical trends. Similar visualizations may be generated based on user completion time, enabling the viewer to assess whether chokepoints/delays in workflow process completion are task-specific, user-specific, or other.

In addition to completion time, many other metrics may be generated and visualizations created by the processor(s) 230 executing instructions of the analytics generation module 218 and the analytics visualization module 220. For example, metrics on individual event types, the types of tasks that make up events, a workflow manager or user to whom a workflow is assigned, number of approval type tasks, number of to-do type tasks, number of rejected events or tasks of an event, number of times a workflow process was restarted, number of documents modified during workflow process completion, and, specific documents required to complete events of a workflow process, and other metrics. The metrics available for visualization may depend on the type of workflow process for which the metrics are generated. As such, the examples shown in visualization GUI 600 are illustrative. An administrator may generate customized reports of visualizations, by selecting those metrics that should be captured in the report.

The generated visualizations may be exported or converted by the processor(s) 230, which captures the GUI in a portable document file (PDF), inserts the visualizations into a document file, or the like. Generated visualizations may also be forwarded to other users, by converting the visualizations into a file and attaching the file to a message to the other users. This message may be generated via an application programing interface accessing an email program on the workflow management computing device 102. Similarly, the message may be generated within the workflow management system 100 and may be sent to a user computer, and appear within an inbox of the workflow application 310 of the user computing device 104. In this way, the workflow management application 210 may use either external or internal messaging instructions to cause the network communication interface 260 to transmit a message with the visualizations attached. By enabling the sharing of visualizations across users of the workflow management system 100, the workflow management application 210 reduced the need for every interested user to rerun or reprocess the analysis models on data sets, which can be resource intensive. Using the report customization and visualization export functions, Administrators can share metrics and visualizations with interested and impacted parties without requiring the additional processing resources of individual reprocessing of the metrics. Further, this messaging may eliminate or reduce the need of users to have direct access to the workflow data 222, thereby reducing cybersecurity risks and privacy compliance breach risks.

Returning to FIG. 4, thee administrative GUI 400 may include a number of additional visual elements associated with functions of the workflow management application 210. For example an administrator may add or modify the number, type, and role of workflow management system participants. New users may be added via a “add a user” visual element. Users may be individual employees or groups of employees. The maximum size of a “user” may be defined by the administrator. User groups may include multiple users and are well suited for assigning events that may have cross-functional tasks. For example, user 106A and user 1068 may be associated with different business units, e.g., product development and legal, but may both be assigned to an event requiring the production and review of a product compliance plan. New user groups can be added via the “add user group” visual element. Selection of this visual element provides the administrator with the functionality to create a user group from previously existing users. The generation of users and user groups results in the generation of a user identifier for the user or group and the storage of both the user identifier and the associated user name or group name within the workflow data 222.

User roles are categories or types of users, which are optionally assigned to users and user groups during generation. Roles may be associated with professions, skills, knowledge, or organizational hierarchy or the like. Example roles include titles such as product manager or patent counsel; or skills such as python, UX development, etc. New roles can be generated after interacting with the “add a role” visual element and completing necessary information fields. Once a role is created, it may be assigned to existing users and user groups. Similarly, new users and user groups may be created with an assigned role. Users and user groups may be associated with multiple roles, e.g., one for title/position, one for hierarchy, and more for skills. Roles are stored in association with users and user groups within a database of the workflow data 222.

Roles enable administrators to assign events of a workflow process to any user of a particular role, instead of looking for specific users. Role-based event assignment is advantageous in instances where any person with a particular skill or authority level can complete tasks associated with the event. Role-based event assignment is achieved during workflow process creation and event assignment by selecting a desired role to which an event should be assigned. In some implementations, the administrator may be further prompted to select from a list of users or user groups of the requested role type, thereby identifying a specific user or user group for assigning the vent. In other implementations, the event is generated without specifying a specific user, and the event assignment module 214 accesses the workflow data 222 to find users of the specified role type, and selects one for event assignment. If the selected user rejects the event assignment, the event assignment module 214 repeats the event assignment based on role. Selection may be random, linear, or based on a queueing analysis in which the user that meets the role specified and has the least number of events assigned may be selected.

The administrative UI 400 provides functionality for adding new document classes or types to the workflow management application 210. Document classes are commonly used documents, templates, or types. The workflow management application 210 may store these document classes in workflow data 222. As workflow processes are generated, administrators may specify document classes to be used during completion of an event. In the example shown of the workflow process “Internet Bill Reimbursement KDDA” a document class for “bill invoice” may be attached to an event “generate invoice.” The administrator may specify the document class to be used when generating the events of the workflow process. By adding frequently used documents or document templates to the events, the workflow management application 210 may enable users to have quick access to these files.

Additionally, an administrator may engage with an “add an attribute” visual element to enable the creation of new metrics to be monitored or collected by the workflow management system 100. Event attributes can include a variety of metrics. For example, completion times, time actually spent on an event, files access during an event, files modified during event completion, users who worked on the event, network addresses of computing devices that worked on or opened files associated with the event, comments regarding event completion, and the like. Although many event attributes may be derived from file and processing characteristics already logged by computing devices, the ability to specify additional attributes may be necessary for metrics that must be derived or calculated from known attributes or computing device characteristics. For example, a start time or end time of an event may be easily determined by viewing a timestamp for event assignment acceptance and the transmission time of an event completion message, or the time at which a document was saved, modified, etc. But, a “total active time on event” may require looking at multiple file modification timestamps, calculating differences, and the summation of those differences. For this reason, the administrative UI 400 may enable the input of new attributes and may optionally receive formula or instructions regarding the calculation or generation of those attributes.

Various UIs of the workflow management application 210 and its component modules may provide additional visual elements that enable functionality for creating, viewing, editing, and otherwise managing workflow processes. Similarly, the workflow management application 210 and its component modules may enable the provision of UI visual elements associated with functionality of monitoring event attributes, generating workflow metrics, generation workflow progress analytics visualizations, and associated customized reports.

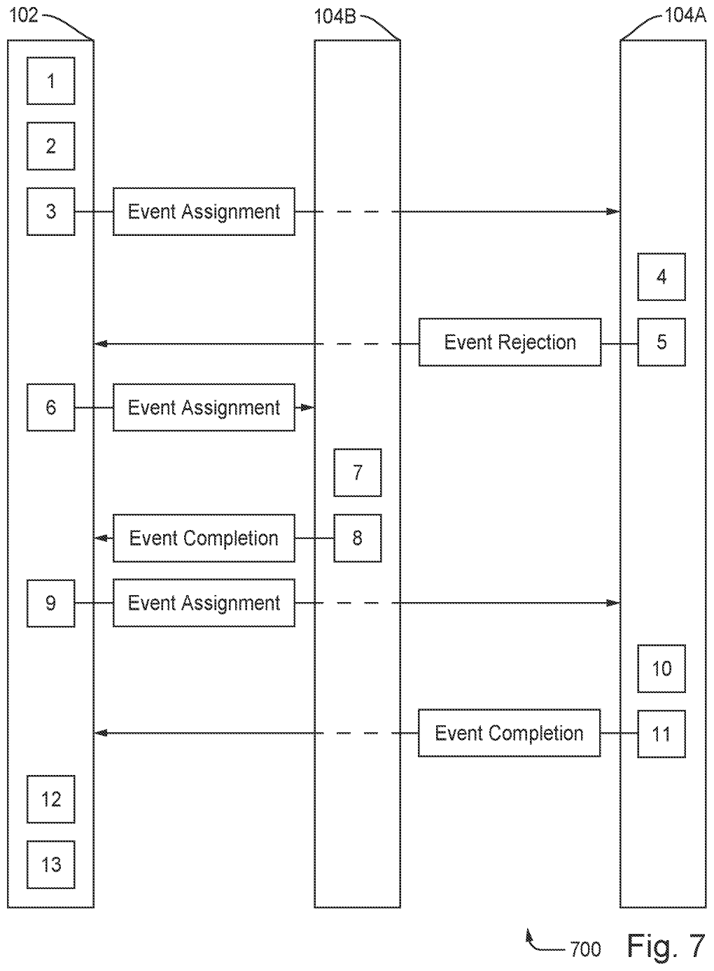

Referring now to FIG. 7, there is shown an example method of workflow process generation and workflow analytics visualization. With reference to FIGS. 1-7, the creation of new workflow processes and the assignment of corresponding events is carried out by the workflow management computing device 102 of FIG. 1. Each workflow process includes multiple events, which may include one or more tasks to be completed by users. Assigning events to users enables an administrator to control who is responsible for event completion and monitor progress.

At block 1, the workflow management computing device 102 generates a workflow process. Block 1 is initiated by workflow process generation module 212 via an instruction from the workflow management application 210 which receives input from indicating a request for a new workflow process. The input is received from the input/output interface 250 as an interaction with a visual element of the administrator UI 400, which is generated by workflow management application 210 and output by display 240. The input request may be the submission of a form or field containing basic information about the new workflow process, such as title, number of events, type of process, due dates etc. Alternatively, this information may be added later, and the input request includes the engagement with a “generate workflow process” visual element on the administrator UI 400.

The generation of a new workflow process includes the creation of a new row in a database of workflow data 222 to store information related to the new workflow process. A workflow process identifier is then generated and assigned to the new workflow process. Workflow process identifiers may be generated sequentially, randomly form a keyspace, or designated by the requesting administrator. Permissions for reading, writing, and editing the workflow process are stored in association with the workflow process identifier to restrict future editing. In some implementations the database may be used to store information about individual events of the workflow process and each event's completion status. In other implementations, a pointer to a data structure containing the events of the workflow process, is stored in the database to enable tracking of event completion.

In various embodiments, a workflow process data structure is created when the first node of the data structure is initialized. The first node contains the workflow process identifier, permissions information, due dates, attributes of interest, and may include iterator pointers for traversing the data structure. If the number of events of the workflow process was provided in the input, then a number of nodes corresponding to the number of events may be initialized. Conversely, events may be added one at a time as details are provided by the administrator. Each event is represented by a node of the data structure, which stores the type or category of event, the user to which the event is assigned, a file or template associated with the event or a link thereto, completion date information, any other relevant data. The category or type of event may be determinative of what information is stored in the event node. Events requiring modification, generation, or review of a file or document may include the file or a link to the file. Further, such event nodes may also include information about the last time the file or document was modified and by which users. The administrator UI 400 may provide input fields, dropdown boxes, attachment/file upload fields, or other methods for receiving information about and files associated with the events of a workflow process. In some implementations, each event may be assigned an identifier to assist in tracking event assignments to users.

Events that are comprised of several tasks may initiate branches or sub lists for those tasks. For example, an event node may include a pointer to a linked list of tasks that must be completed in order to complete the event. Iterators may also be initiated to track progress in completing the tasks. In this way, the multiple tasks may operate similarly to a nested or child workflow process of the parent workflow process

After workflow process generation is complete, the workflow data 222 has been updated to include the workflow process information in the database, and may also include the data structure representing the workflow process individually. That is, after each workflow process is generated by the processor(s) 230 executing the workflow management application 210, the database which maintains data about all workflow processes of the workflow system 100 will be updated and a data structure representing the individual workflow process will have been created. This enables rapid lookup of workflow process information in the database, as well as granular event and task tracking via the data structure.

At block 2, the various events of the workflow process are assigned to one or more users 106 of the workflow management system 100. The assignment of events to users may occur according to several variations. A direct assignment option may be provided via the administrator UI 400 and enable administrators to assign specific users to events. Information for individual events may be displayed as part of the UI, along with fields, text boxes, drop down menus, or other means of accepting input specifying a user to whom the event should be assigned. The administrator inputs a user name or identifier using the input//output interface 250. Receipt of the input causes the processor(s) 230 to access the workflow data 222, e.g., the database, to match the provided name or identifier to an entry in the database. An entry associated with the user may be updated to indicate that the user is now responsible for the event. According to some implementations, a database entry associated with the event may be updated to include the user identifier to which the event is assigned. Similarly, an event node of the workflow process data structure is updated to write the user identifier into the node as the responsible user. In some cases, the processor(s) 230 may need to look up the user identifier in the database based on the input provided by the administrator before a database entry or event node can be updated. This process may repeat for each event of the workflow process until all events are assigned to a user 106A-B. The UI may advance after each event assignment, updating the information output to display 240 to reflect the event information for the next event of the workflow process that is ready for assignment.

In some implementations, the administrator may assign events to users by specifying a role rather than a user. As discussed with reference to FIG. 4, roles may be categories or types of users. In role-specific user assignment, the administrator inputs a role instead of a user name or user identifier. As with the user name or identifier, the role may be specified via input to a text field, drop down box, or other UI element. The administrator may select multiple roles. For example, roles selected for a “approve design brief” event may include roles such as “project manager” and “product design division.” From this input, the processor(s) 230 determines that any user who has both a “project manager” role and a “product design division” role stored in association with tier user identifier in the database, can be selected for event assignment. In one implementation, the processor(s) executing the event assignment module 214 may query the database in workflow data 222 and may assign the event to the first user meeting the role requirements. In another implementation, the processor(s) 230 queries the database for users meeting the role requirements and randomly assigns the event to a user within the query reply set. In another implementation, the processor(s) 230 queries the database and assigns the event to the user who meets the role requirements and has the fewest number of open event assignments at a given time. In another implementation, the processor(s) may query the database for users meeting the role requirements and passes the query return set to the display 240 for output. The administrator may then select a user from among the displayed users who meet the role requirements. As with user-specific event assignment, the database and any event nodes may be updated to reflect not only the user identifier of a user assigned to the event, but also the role requirements. This may enable easy even reassignment if a user is unable to complete the event or rejects the event assignment.

The roles associated with a user may change over time as users move throughout an Organization and transition into different positions. Administrators can update user role associations via the administrator UI 400, which instructs the processor(s) 230 to write the new roles to the database in workflow data 222. If a user has previously accepted an event assignment, but then changes roles such that the user no longer meets the role requirements, the event tracking module 312 of the workflow application 310 executing on the user computing device 104A-D, may reject the event assignment. The workflow management computing device 102 receives the event rejection message indicating the role with which the user is no longer associated. The workflow management application 210 then uses event assignment module 214 to check the event node of the data structure for the role requirements of the event, queries the database for users meeting the role requirements, and may assign a new user to the event according to the implementations described above.

Events may also be assigned by automatic or batch event assignment. In such implementations, the administrator may select multiple events of a workflow process via the administrator UI 400 and may specify a user or role(s) to which the events should be assigned. The processor(s) 230 may then query the database for users, update the database, and update the event nodes without requiring additional user input for each event. It should be noted that batch event assignment does not necessitate that all event assignment messages are sent out in a batch fashion. Event assignments may be sent out in serial fashion, i.e., as events are completed (as shown in FIG. 7), in parallel, or in batches, regardless of the method of assignment.

In block 3, users 106A-B are notified of event assignments in an event assignment message. This may happen proactively via a message transmitted from the workflow management computing device 102 to respective user computing devices 104A-D. Proactive event assignment message transmission may occur as events are assigned or in a bath manner, such as all events of a workflow process being generated and then transmitted. Event assignment messages may also be provided to the user computing devices 104A-D, when the user computing device 104A logs in to the workflow management system 100, e.g., the workflow management computing device 102 or a server associated therewith and hosting the workflow data 222. Message structure may vary slightly based on the messaging protocol used to transmit the event assignment message.

Event assignment messages include information related to the requirements for event completion by the user to which the event is assigned. The event assignment module 214 of the workflow management application 210, generates an electronic message including a user identifier of the user to which the event is assigned, a workflow process identifier of the workflow process that includes the event, tasks that must be completed, event attributes to be generated or collected, due dates, optionally the event assignment message may include roles associated with the user or that are relevant to the event. The event assignment message may include a link to the event node of the workflow process, for use in tracking even completion progress. Documents, document templates, or other files needed to complete the event may be attached to the event assignment message. Alternatively, links to the documents or files may be attached to the event assignment message to reduce the amount of data being transmitted. Providing a link or pointer to the event node may enable the workflow application 310 executing on the user computing device 104A to access files and information associated with the event, without requiring that that the files be attached to the event assignment message. In the most lightweight implementations, the event assignment message includes the user identifier and a link or pointer to the event node, where information about the event can be fetched by the workflow application 310 of the user computing device 104A.

Events associated with document creation or modification, may be automatically evaluated for completeness. When an event relates to the generation or modification of a document or file, a link to the memory location of the document, file or template may be stored in association with the event node within a data structure of the workflow process. The document file or a link to the file's location is transmitted along with the event assignment message to a user. Once the event assignment has been accepted, the workflow management computing device 102 executing the tracking module 216, can determine whether the file been used, modified, or generated, and thus automatically determine if a task or event has been completed.

In some implementations, event assignment messages may be user-specific, and may be generated for a particular user. This may enable grouping of multiple event assignments into a single event assignment message. Any combination of the above data may be included in the user-centric event assignment message to provide the receiving user with information about each even assigned. This may occur automatically when the administrator generates events of the workflow process via batch generation. The event assignment module 214 may determine whether event assignment messages should be generated for each event or grouped for specific users based on the event generation process or the presence of unique user identifiers within the pool of users to which events are assigned.

In block 4, the workflow application 310 of the user computing device 104A receives an event assignment message. The network communication interface 360 of the user computing device 104A receives the event assignment message and the processor(s) 330 executing the workflow application 310 may output event information to the display 340 for user approval. The event assignment message may be received proactively from the workflow management computing device 102. The event assignment message may also be received in response to a query from the workflow application 310 of the user computing device 104A to the workflow management computing device 102 or a server associated therewith. Queries for new event assignments may be made upon workflow application 310 start up or at regular intervals to ensure that event assignments are detected in a timely manner.

The workflow application 310 receives the event assignment message from the processor(s) 330 and outputs the message for display to the user 106A. Data included in the event assignment message is displayed in a UI on the user computing device 104A. Information associated with the event may be obtained from the event assignment message, or via the link to the event node or database, as provided in the event assignment message. The user 106A views the tasks associated with completing the task, the due dates, and any deliverables information provided on the UI. One or more visual elements enabling acceptance or rejection of the event may be provided in the UI. Selection of the visual elements instructs the workflow application 310 to either accept or reject the event. Acceptance of the event assignment results in responsibility for the event's completion being confirmed by the user and the event racking module 314 adding the event to the user's assignments queue. Rejection of the event assignment causes the event tracking module 312 to generate and transmit an event rejection message to the workflow management computing device 102.

In block 5, the event assigned to the user 105A of user computing device 104A is rejected and an event rejection message is transmitted to the workflow management computing device. The user 105A may reject an event for any number of reasons, such as too many other responsibilities, lacking necessary skills, etc. This may be done manually by the user 106A by engaging with the UI of the workflow application 310. Rejection may also occur if a user who has previously accepted the event assignment changes roles and no longer meets the role requirements for the event. For example, an event assigned to a data scientist within a business analytics engineering team may later be rejected if the data scientist move into a project management role or moves to a different team. This rejection may occur automatically, when the workflow application 310 start up or queries the workflow management computing device 102 or a server associated therewith for current event assignment information.

Event rejections messages are transmitted to the workflow computing device 102, which may update the workflow data 222 to reflect the rejection. In some implementations, the event rejection message may be a message including some or all of the event information included in the original event assignment message along with an indicator that the event has been rejected. In other implementations, the event rejection message may be a message containing an instruction to update the event node or database to reflect that user 106 A is not responsible for the event.

In some embodiments, event rejection messages may include a rejection code identifying a reason the event was rejected. Rejection codes may relate to the user's workload, a change in roles, a change in teams, lack of authority, etc. Including an event rejection code in the event rejection message may enable tracking of rejections and the generation of metrics related to which users and roles most often reject events, how often certain types of events are rejected, and the like.

In block 6, the workflow management computing device 102 receives, via the network communication interface 260, the event rejection message, updates the event assignment and transmits a second event assignment message to a new user computing device 1048. The tacking module 215 of the workflow computing device may update the workflow data 222 to indicate that the user 106A is no longer the responsible user for the event, and may then pass the event to the event assignment module 214 for reassignment. The event assignment module 214 may automatically reassign the event if the original assignment was automatic or role-based. Automatic reassignment may happen according to the same criteria as discussed with reference to block 2.

However, reassignment may also require manual input by the administrator if the original assignment was user-based and made manually by. This can occur by way of a prompt or notification displayed to the administrator in the administrative UI 400. After the event is reassigned by the event assignment module 214, the database and the event node of the data structure are updated to indicate the user identifier of the user to whom the event is now assigned. The user identifier of the rejecting user 105A may be stored or retained in the event node and database to prevent future reassignment of the event to that user, and to enable metrics generation.

In block 7, the event tracking module 312 of the user computing device 1048 enables the user 1068 to accept the event assignment, and updates event data 314 to include the event. Event assignments are accepted via a UI of the workflow application 310 as discussed with reference to blocks 4 and 5. The event data 314 may be a data structure or database including all events assigned to the user 1068. For example a table may include the event information for each event assigned to the user. For the purposes of providing a clear disclosure, the database or data structure containing event assignment information may be referred to as the event assignment queue. For events that include multiple tasks, the event assignment queue may include the tasks represented in linear form, or a pointer to a data structure including all the tasks for the event. That is, the event assignment queue may include pointers to linked lists or tree structures containing information about the tasks needed to complete the event. Contents of the event assignment queue are accessible via the UI of the workflow application 310 to provide users with information about their completed and outstanding events.

In some embodiments, the event tracking module 312 may generate an event acceptance message and pass the message to the network communication interface 360 for transmission to the workflow management computing device 102. The workflow management computing device 102 may receive this event acceptance message and update the workflow data 222 to reflect that the user is the responsible user for the event. The contents of the event acceptance message may include the user identifier and acceptance code or bit. In other embodiments, the event acceptance message may be an instruction to modify the event node of the data structure to indicate that the user is responsible for event completion.

In block 8, the user computing device 1048 completes the assigned event and transmits an event completion message to the workflow management computing device 102. The event tracking module 312 generates the event completion message in response to either an input by the user indicating that the event has been completed, or detecting by the workflow application 310 that the event has been completed. The event tracking module generates a message including the user identifier, the workflow process identifier, and any event attributes collected or generated during completion of the event.

In some embodiments, an event is marked as completed via manual input to a UI of the workflow application 310. The user 1068 provides input via the input/output interface 350 to interact with a visual element of the UI associated with event completion. The visual element may be a check box, a drop down selection, a text field for inputting user initials or user identifier, etc. A timestamp is assigned to the event as the completion time based on the time at which the input is provided or submitted to the workflow application 310. The event tracking module 312 updates the event data 314 to indicate that the event is complete. The event tracking module 312 also generates the event completion message and, via the processor(s) 330, passes the event completion message to the network communication interface for transmission to the workflow management computing device 102. Tasks of an event may be similarly manually marked as completed and the event dada 314 updated to reflect that the task is complete, but not necessarily the event. Task completion and time stamps are stored in the event assignment queue in association with the event. Manual event completion may be well0suited to tasks involving user review, such as approval tasks, review tasks, manual operations tasks, and other tasks that do not result in the generation or modification of files.

In some embodiments, the event tracking module 312 may automatically detect when a file has been created, modified, etc. In such embodiments, the workflow application receives, in the event assignment message either a copy of the file, template, or document, or a link to the location of same in memory or within the file structure of the workflow system 100. For events requiring file generation, the event tracking module 314 may monitor a file folder within the file structure for generation of new files of a type or name matching that specified in the event information. Upon detection of a new file meeting the event requirements being created within the file folder, the event tracking module 312 prompts the user via the UI to confirm that the event is completed. Confirmation of the event completion is carried out in the same manner as a manual completion. For events requiring modification of a template, document, or file, the event tracking module 312 monitors the storage location (in memory or file structure) of the file and checks the dirty bit or modification bit for changes. The storage location may be one assigned bon the user computing device 1048, such as when the file is included in the event assignment message, or a storage location on the workflow management computing device 102 or server connected therewith, as indicated via the link in the event assignment message. Upon detection of the change to the dirty bit, the event tracking module 312 prompts the user to confirm that the event has been completed.

In some implementations, event completion is detected automatically and the event completion message transmitted to the workflow management computing device 102 without prompting the user for input or confirmation of even completion. This may occur in situations where the event requires updating of a template, or approval via a selection mechanism, among other types of tasks. Completion may be automatically detected and reported in such cases because the engagement with the selection mechanism is determined to be an affirmation that the task is complete.

While event or its tasks are being worked on, the event racking module 312 may collect a variety of information about the user's usage patterns as related to the event. For example, the event tracking module 312 may determine a number of times that the file was opened or accessed, a number of time sit was modified, the number of users how accessed the file during event completion, which users accessed the file during event completion, an average duration of time that the file was open, and the like. This information may be stored in the event data 314 in association with the event or its tasks. This data may be collected during event completion, or may be generated after event completion based on specific attributes requested by the workflow management computing device 102 in the event assignment message. In some implementations the event tracking module 312 only collects data, but does not generate or calculate new attributes, instead passing the collected data to the workflow management computing device 102 in the event completion message for further calculation. In some implementations the workflow application 310 calculate the requested event attributes and transmits them along with collected data to the workflow management computing device 102 in the event completion message.

In implementations, such as those in which the event is a lengthy, ongoing project, event attributes may be transmitted by the event tracking module 312 to the workflow management computing device 102 at regular intervals or as tasks are completed, without waiting for final completion of the event. That is, periodic event message may be transmitted to the workflow management computing device to provide updates to event attributes collected by the user computing device 1048. This may enable the generation of workflow process analytics about an event prior to completion of the event. Such implementations are useful in identifying process bottlenecks prior to completion of the workflow process as a whole.

In block 9, the workflow management computing device 102 receives the event completion message and uses its contents to update the workflow data 222; and optionally makes and transmits the next event assignment. The event completion message contains various event attributes collected by the user computing device 1048 during work on the event. Event attributes are stored in the workflow data 222 for use in workflow progress analytics generation. The analytics generation module 218 then compares the types of event attributes included in the event completion message against requested event attribute types stored in the database and, or the event node for the completed event. If the requested event attributes are of a type that is not included in the event completion message, but can be calculated from the event attributes included in the message, then the analytics generation module 218 calculates these event attributes and stores them in the workflow data 222. As an example, a total duration of event completion may be calculated by subtracting the event assignment time from the event completion time. A wide variety of administrator designated event attributes may be calculated and stored in the workflow data 22.

In some implementations, the workflow management computing device 102 may only store raw data of event attributes in the workflow data 222. Event attributes that must be calculated based on the draw data are calculated on demand in order to meet requests via the visualization UI 600. Such implementations may reduce the number of processes handled by processor(s) 230 while managing workflow process completion; saving calculation of event attributes as on-demand batch processes.

The tracking module 216 updates the database and the event node associated with the completed event to reflect that the event is no longer the current event of the workflow process. This may include storing a completion time in the workflow data 222. This also includes advancing an iterator of the workflow process data structure to the next event to be completed. The pointer stored in the database that points to the current event of the workflow process, is thus updated to point to the next node in the workflow process data structure.

In the embodiment illustrated in FIG. 7, the event assignment messages are sent out in serial fashion such that each event assignment message is transmitted by the workflow management computing device 102 after receiving an event completion message for the preceding event in the workflow process. Once the next event in the workflow process is identified, the tracking module 216 determines whether an event assignment has already been made by reviewing the workflow data 22, e.g. the event node for a user identifier assigned to the event. If the event has already been assigned to a user, the workflow management application 210 generates and transmits an event assignment message to the user associated with the user identifier. This occurs in a manner as described with reference to block 3. If no event assignment has been made, or the event assignment is invalid (e.g., the user is no longer with the Organization), then the event assignment module 214 performs a new assignment in a manner as describe with reference to block 2. The event assignment message is then generated and transmitted with the new user assignment information included.

In block 10, the user computing device 104A receives the next event assignment message and accepts the event assignment. Prior rejection of events of workflow process may not prevent future event assignments to the user 104A. Whether new events of the same workflow may be assigned to a user after a prior event assignment has been rejected, depends, at least in part, on the rejection code provided in the event rejection message. If the rejection code indicates that the reason for event assignment rejection relates to a lack of time or resources, or inappropriate role requirements, the user may be assigned a future event. However, if the rejection code indicates that role is inappropriate, and future events require a role the user does not have, then no new events of the workflow process will be assigned to the user. Administrators may use the administrative UI 400 to place constraints on event assignment to users who reject events. The acceptance of the event assignment and storage of event information by the event tracking module 312 proceed in a manner as described with reference to block 7.

In block 11, the user computing device 104A completes the assigned event, generates an event completion message, and transmits the message to the workflow management computing device 102. This may occur in the same manner as described with reference to block 8.

In block 12, the workflow management computing device 102 generates workflow progress analytics using the analytics generation module 218. The analytics generation module 218 uses the event attributes and other workflow data 222 to calculate workflow progress analytics. The analytics generation module 218 applies one or more data analysis models to the event attributes or other workflow data 222 to generate the workflow progress analytics. That is, workflow progress analytics may be generated for one or more events of a workflow process in order to gain insights into the current status of a project; or the workflow progress analytics may be generated at the end of workflow process completion to obtain information about the nature of workflow process completion. In various s embodiments, the workflow progress analytics are generated by the workflow management computing device.

Various data analytics techniques and software packages may be used to generate the workflow progress analytics. In general, the techniques may be related to diagnostic analysis or descriptive analysis applied to event attributes of one or more workflow processes. Descriptive analysis include measures of frequency that show how often something occurs, e.g., frequency, relative frequency, and the cumulative relative frequency. Descriptive analysis also includes measures of central tendency that show the averages of an event attribute dataset. Descriptive analysis includes measures of dispersion or variation that illustrate how dispersed or diverse the values of the event attribute dataset is, such as the range, variance, standard deviation, skewness, and kurtosis. Descriptive analysis further includes measures of position that show how the values fall in relation to one another, such as the percentile and quartile ranks. Diagnostic analysis techniques can identify anomalies in event attribute and workflow data 222. Such techniques can uncover hidden relationships between event attributes or other workflow data 222 that led to the anomaly. Different techniques such as probability theory, regression analysis, filtering, and time-series data analytics can be used to identify these anomalies. The exact technique or techniques used to generate the workflow progress analytics depends on the event attributes available and the information desired by the requestor. An example technique to be applied is data mining which combines methods of machine learning, statistics, and database systems management to derive patterns between event attributes in the dataset. Data mining is models may assist in uncovering previously-unknown patterns that can help explain what led to a certain event to occur.

The analytics generation module 218 determines which techniques to apply using a table, tree, or expert systems that map types of analytics to an analytics model. For example, the UI receives an administrator input indicating a desired set of workflow progress analytics, and uses the input as a query or search seed for the table, tree, or expert system. The result of the look up may be an analytics model, a script, or template, to be applied to the event attributes. In some implementations, the administrator may be provided with a visual element of the UI that enables selection of the analytics model, thereby circumventing the need to use the table, tree, or expert system.

The workflow progress analytics generated by the analytics generation module 218 are selected by an administrator via the visualization UI 600 or other UI rendered by the workflow management application 210. The administrator may select from available options, or specify specific parameters of interest using the input/output interface 250. Workflow progress analytics may be generated as part of processing a request for a visualization, or as a separate request for analytics generation. The administrator may specify which request is being made using the visualization UI 600. An example of a workflow progress metric is an average event completion time by a user group for a particular type of event. Upon receiving the request, the analytics generation module 218 searches the workflow data 222 to find completion time data, start time, and, or end time data for events of the specified type that were completed by the specified user group. The mean, median, quartiles, standard deviation, and similar information may be displayed for the administrator in response to the request. Other examples of workflow progress analytics may include analytics for a user to which an event of the workflow process is assigned, and wherein the workflow progress analytics for the user include one or more of a number of electronic documents modified by the user during completion of each event assigned to the user, number of users assigned to the event, and electronic documents accessed in completion of the event.

In block 13, the workflow management computing device may use the analytics visualization module 220 of the workflow management application 210 to generate one or more visuals representing the generated workflow progress analytics. As shown in FIG. 6, the visualization UI 600 may be updated to include several graphical representations of workflow progress analytics. Graphical representations include tables illustrating workflow progress analytics, bar graphs, box plots, pie charts, scatter plots, Venn diagrams, process flow representations, etc. As with the workflow analytics generation, selection of visualizations may be provided via user input, or determined automatically. Automatic determination of visualizations can occur when the analytics generation module 218 informs the analytics visualization module 220 of the analytics model applied, the event attributes and workflow data used to generate the analytics, and the resulting workflow progress analytics. At least a portion of this information is used by the analytics visualization module 220 as a query or search seed for a table, tree or expert system that maps types of workflow progress analytics of analytics models to visualization types. In some implementations the table, tree, or expert system of the analytics generation module 219 may be the same, and or integrated into the table, tree, or expert system of the analytics visualization module 220. The displayed graphical representations of the workflow progress analytics may be changed or updated as requested via input from the administrator to the visualization UI 600. In this manner, an administrator can look at many different visualizations for different workflow progress analytics, and use this information to identify trends in workflow process completion. Identifying these trends can enable troubleshooting of problem areas or rewarding efficient event completion.

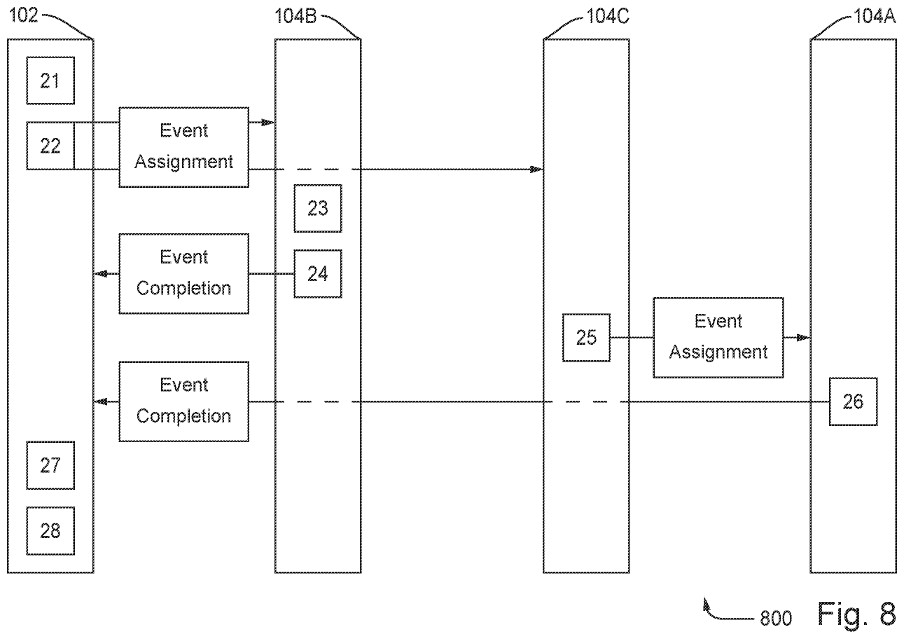

Referring to FIG. 8, there is shown an exemplary workflow process completion according to an embodiment. With reference to FIGS. 1-8, the workflow management computing device 102 may execute various modules of the workflow management application 210 to generate workflow processes and assign events to various users 105A-B. The message flow illustrated in FIG. 8 represents implementations in which event assignment messages are transmitted to users 106A-B in parallel, irrespective of the event completion dependencies amongst assigned events.

In block 21, the workflow generation module 212 may generate a workflow process in substantially the same manner as described with reference to block 2 of FIG. 7.

In block 22, the event assignment module 214, may assign events to users and generate corresponding event assignment messages in a manner substantially similar to that described with reference to blocks 2 and 3 of FIG. 7. However, in the implementation of FIG. 8, event assignment messages are sent out in parallel to a user's to whom events have been assigned. Regardless of whether the event assignments were made individually or in a batch process, the event assignment messages may be generated and transmitted in a batch or bulk process. One or more assigned events may be contained in each event assignment message. The event assignment messages are transmitted to user computing devices 104B and 104C. All event assignment messages are thus transmitted without waiting for completion of any one event.

In blocks 23, the user computing device 104B may receive the event assignment message, accept the event assignment in a manner substantially similar to that described with reference to block 7 of FIG. 7. In block 24, the user computing device 104B may complete the event and transmit an event completion message to the workflow management computing device in a manner substantially similar to that described with reference to block 7 of FIG. 7.

In block 25, the user computing device 104C rejects the event assignment, and forwards the event assignment message to another member of the user 104 A. The user computing device 104C workflow application 310 can use the role information provided in an event assignment message to identify other user capable of meeting the role requirements for completing the event. The workflow application 310 can display forwarding suggesting via a UI on the user computing device 104C. The user 106 selects a user to forward the event assignment and submits. Alternatively, the user may input the user name or user identifier of the forwardee into the UI, in a manual selection implementation. The event tracking module 312 updates or modifies the event assignment message to replace the user identifier associated with the user of user computing device 14C with the user of user computing device 104A. The modified event assignment message is then transmitted to the user of user computing device 104C. In some implementations, an event rejection message including the rejection code associated with forwarding, and the new user identifier may be transmitted to hew workflow management computing device for addition to the workflow data 222 as the current user responsible for the event.

In blocks 26, the user computing device 104A may receive the event assignment message, accept the event assignment, complete the event, and transmit an event completion message to the workflow management computing device in a manner substantially similar to that described with reference to blocks 7 and 8 of FIG. 7.

In block 27, the workflow management computing device 102 receives the event completion message, and generates workflow progress analytics in a manner substantially similar to that described with reference to block 2 of FIG. 7. In block 28, the workflow management computing device 102 generates visualizations of the workflow progress analytics in a manner substantially similar to that described with reference to block 13 of FIG. 7.

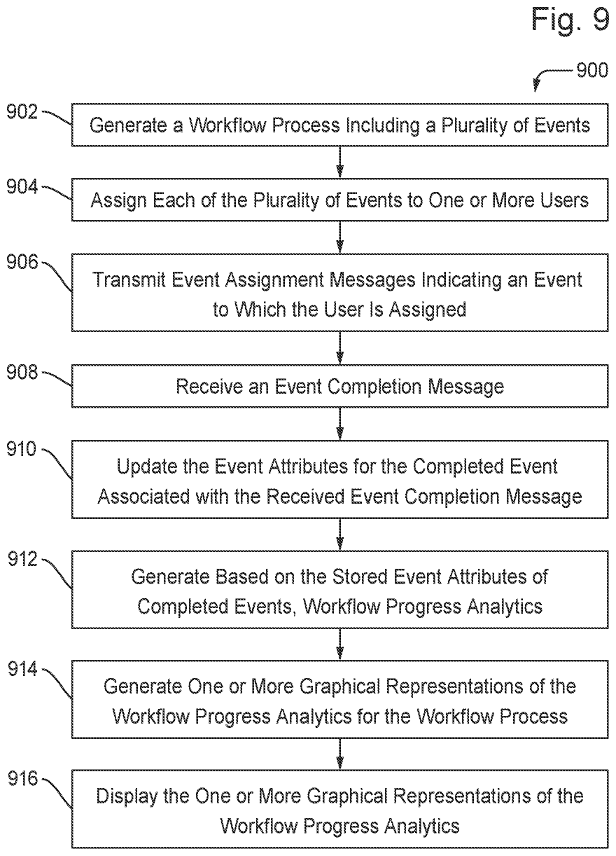

Referring to FIG. 9, there is shown, a method for producing workflow progress analytics. With reference to FIGS. 1-9, the workflow management system 100 captures data about the manner in which work is completed (i.e., event attributes) and uses this information to generate analytics characterizing the progress of work. These analytics may be useful, as various statistics may be generated using the analytics data. Further, visualizations may be generated from the analytics to provide a visual indication of changes in workflow over time, comparisons of event progress, and other useful information.

In block 902, the processor(s) 230 may generate and store in a data storage, a workflow process including a plurality of events. That is, the processor(s) 230 executing the workflow generation module 212 of the workflow management application 210 stored in memory 202, may generate a data structure representing a new workflow process. The workflow process may have a number of nodes associated with events that are added to the workflow process. The workflow process is assigned a workflow process identifier, which is stored along with a link or pointer to the workflow process data structure in a database. Iterators may also be initiated and stored with the workflow process identifier to point to current event nodes of the workflow process data structure.

Each node of the workflow process data structure represents an event. A single event can include multiple tasks to be completed before the event is considered completed. This is because a portion of a workflow process may require many small steps to be completed by the same user before progress towards workflow completion advances. That is, the user to whom the event is assigned must complete several tasks before responsibility for event completion advances to the next event and the next user. An event identifier, tasks needed in order to complete the event, and any due dates, may be stored in an event node. Documents or document templates related to tasks of the event, or a link thereto, may also be stored in an event node to enable tracking of modifications to the document or document template. Files related to task completion may also be stored in whole or via link to a location in memory, in an event node.

In block 904, the processor(s) 230 may assign each of the plurality of events to one or more users of a user population. That is, the processor(s) 230 executing the event assignment module 214 of the workflow management application 210 stored in memory 202, may match each of the events of the workflow process to a user 106A, 106B. The event assignment module 214 includes instructions for enabling an administrator to specify particular users to which an event should be assigned; or suggest users based on roles of users 106A-B. As event assignments are made, the event assignment module 214 causes the processor(s) 230 to add a user identifier to the workflow data 22 in association with the event. This may be accomplished by updating the event node of a data structure to include the user identifier of the responsible user, e.g., user 106A. This may also be accomplished by updating a database entry associated with the event to include the user identifier.

In block 906, the network communication interface 260 transmits to computing devices of each of the one or more users, event assignment messages indicating an event to which the user is assigned. That is, the processor(s) 230 executing the event assignment module 214 of the workflow management application 210 stored in memory 202, may generate an event assignment message for the plurality of events and pass them to the network communication interface 260 for transmission. Each event assignment message includes a user identifier for the user to which the event is assigned, workflow process identifier, and a request for event attributes associated with the event's completion.

Event assignment message generation may be event-centric or user-centric. Event-centric implementations include the generation of an event assignment message for each event of the plurality of events, regardless of whether duplicate users are involved. User-specific implementations include the generation of event assignment messages for each user, in which a single event assignment message for a user may include multiple events. The user-centric implementation may be well-suited to batch event generation methods. Thus, the event assignment message generation may vary slightly depending on the method used by the administrator to generate the events of the workflow process or based on whether all event assignments are made to unique user identifiers.

The network communication interface 260 transmits the event assignment messages in a proactive manner or an on-demand manner. Proactive methods include the generation and transmission of event assignment message after workflow process generation. On-demand methods include the generation and transmission of event assignment messages upon receipt of a query from a user computing device 104A as to whether the user 106A has any new event assignments. In either case, the event assignment message is an electronic message including information about the event to be completed by the user identified in the message.

In block 908, the network communication interface 260 may receive an event completion message from a computing device of a first user, indicating that an event assigned to the first user has been completed, wherein the event completion message includes event attributes for the completed event. That is, the processor(s) 230 executing the tracking module 216 of the workflow management application 210 stored in memory 202, may receive via the network communication interface 260 an event completion message. The event completion message may include the user identifier of the user who completed the event, a workflow process identifier indicating the workflow process to which the event belongs, and any event attributes requested by the workflow management computing device 102.

In block 910, the processor(s) 230 may update, in the data storage, the event attributes for the completed event associated with the received event completion message. That is, the processor(s) 230 executing the tracking module 216 of the workflow management application 210 stored in memory 202, may update the workflow data 222 to include the event attributes included in the event completion message. Updating the workflow data 222 can include updating the database and the event node of the workflow process data structure to include some of all of the event attributes. Additional event attributes may be calculated or generated by analytics generation module 218 based, at least in part, on some of the received event attributes.

In block 912, the processor(s) 230 may generate, based, at least in part, on the stored event attributes, workflow progress analytics. That is, the processor(s) 230 executing the analytics generation module 218 of the workflow management application 210 stored in memory 202, may calculate or otherwise generate one or more workflow progress analytics using the workflow data, specifically the event attributes stored in the workflow data. The analytics generation module 218 may receive a request from to UI of the workflow management application 210, the request including one or more analytics or event attributes for which analytics are requested. Based on the requested analytics, the processor(s) 230 may determine an analytics model to be applied to event attributes within the workflow data 222. For commonly received requests, the workflow management application 210 may have a script or template including one or more analytics models that can be used to generate multiple sets of workflow progress analytics. The analytics specified in the request guide or dictate the model to be applied and the event attributes to which it should be applied. The analytics generation module 218 may include multiple models and software instructions for executing them. This may include a system for determining which model to apply, such as a table linking types of models to different analytics requests types. Similarly, an expert system or tree may be employed to select models to be applied to the workflow progress analytics.

In block 914, the processor(s) may generate one or more graphical representations of the workflow progress analytics for the workflow process. That is, the processor(s) 230 executing the analytics visualization module 220 of the workflow management application 210 stored in memory 202, may generate one or more visualizations or graphical representations of the workflow progress analytics. These visualizations may be scatter plots, box plots, bar graphics, pie charts, and the like. The visualization generated is dependent on the workflow progress analytics that the visualization represents. As with the analytics generation module 218, the analytics visualization may include software instructions indicating how to select the visualization to render. The analytics visualization module 220 may include a table, an expert system, or tree mapping visualizations to different workflow progress analytics types. Once a visualization has been selected based on the generated workflow progress analytics, the analytics visualization module 220 generates the graphics and passes them to the display 240.

In block 916, the display 240 displays via a graphical user interface on the display of the workflow management computing device, the one or more graphical representations of the workflow progress analytics. That is, the display 240 of the workflow management computing device 102 may output the visualization UI 600 including the generated graphical representations of the workflow progress analytics. The graphical representations may be displayed as elements of the visualization UI 600 or other UI of the workflow management application 210. For example, the graphical representations may include pie charts comparing time or resource consumption by different users during completion of the workflow process. User assignments may be displayed as a visualization element.

The above-described embodiments provide solutions to workflow progress management challenges using data analytics and visualization. By enabling the identification and visualization of workflow process chokepoints, such as file handling and versioning difficulties, and user data handling inefficiencies, the various embodiments may improve scalability, timeliness of workflow completion, and efficiency of goal completion. By monitoring and analyzing data related to workflow completion by various organizational participants. The various embodiments disclose methods for maintaining data about the most current status, version, and modification of data, files, and event completion throughout stages of a workflow process. This information is collected from all workflow contributors across organizational units and systems, and is maintained by a workflow management computing device. In this way, a workflow management computing device can monitor and analyze workflow progress across all organizational units and systems, regardless of original ownership of data, files, materials, or applications used in workflow completion. The results of workflow progress analysis may be used to generate visualizations illustrating characteristics of workflow completion as it applies to participants. Various data visualization modes may be used to provide customizable visualization experiences for users of different teams, units, or systems.

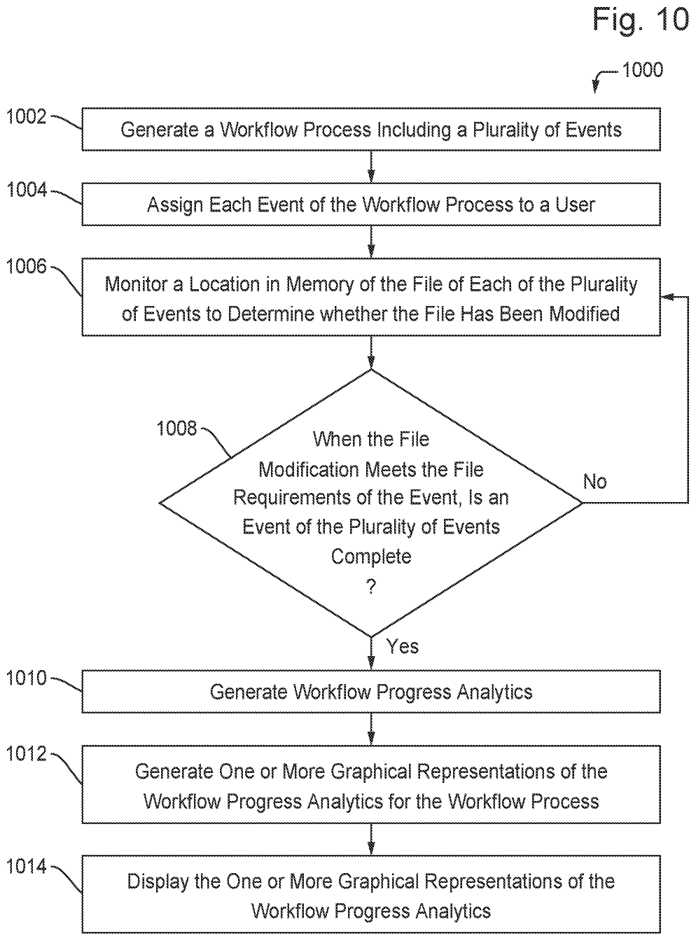

Referring to FIG. 10, there is shown a method 1000 for event completion detection by a workflow management computing device. With reference to FIGS. 1-10, the workflow management computing device 102 may monitor or track utilization or generation of files associated with assigned events in order to automatically detect event completion. For events that require the completion of several tasks in order for the event to be completed, the workflow management computing device 102 may apply the same techniques to auto detect completion of tasks associated with files.

In block 1002, the processor of the workflow management computing device 102 may generate generating, in the data storage, a workflow process including a plurality of events each event including an event identifier and a document file. That is, the workflow generation module 212 executed by processor(s) 230 may generate a workflow process having multiple events, as described with reference to block 902 of FIG. 9.

In block 1004, the processor of the workflow management computing device 102 may assign each event of the workflow process to a user. That is, the event assignment module 314 executed by processor(s) 230 may assign the various events to one or more users as described with reference to block 904 of FIG. 9.

In block 1006, the processor of the workflow management computing device 102 may monitor a location in memory of the document file of each of the plurality of events to determine whether the file has been modified according to requirements of the event to which it belongs. That is, tracking module 216 executed by processor(s) 230 may monitor a location in memory or file system address at which a file is stored, the file having been associated with one of the plurality of events during the workflow process generation. The tracking module 216 may check a dirty bit or other modifier bit of a file to determine if modifications have been made, and may similarly check the time at which a file modification has occurred. In some instances, an event may require generation of a new file or a copy of an existing file, such as when a template is modified to generate a new file. The tracking module 216 monitors an assigned storage location for the new file to determine when the new file is generated. For example, the tracking module 216 may check a file folder within the file structure that is assigned to storing invoices, and may determine when an invoice file corresponding to the assigned event has been created and stored me the file folder. In some implementations the location in memory may be on a different computing device such as a server associated with the workflow management computing device. Status query messages may be transmitted to the server to check on the status of the file. When the file is modified or generated, the server may respond in the affirmative via a status confirmation message.

In block 10008, the processor of the workflow management computing device 102 may determine that an event of the plurality of events is complete when the document file modification meets the file requirements of the event. That is, tracking module 216 executed by processor(s) 230 may detect that a file has been generated at or modified a location in memory or file system address. Once the modification or file creation is detected, the processor(s) 230 may, by executing tracking module 216 mark the event or task with which the file is associated, as complete. The tracking module 316 updates an event node o the completed event to indicate one or more event attributes and completion timestamp. A pointer to the current event node may be advanced to the next event in the workflow process data structure. A corresponding entry in the database of the event data 222 is updated to reflect the current event and the current pointe target.

In block 1010, the processor of the workflow management computing device 102 may generate, based on event attributes of the workflow process, workflow progress analytics. That is, the analytics generation module 218 executed by processor(s) 230 may generate a set of workflow progress analytics as described with reference to block 912 of FIG. 9.

In block 1012, the processor of the workflow management computing device 102 may generating one or more graphical representations of the workflow progress analytics for the workflow process. That is, the analytics visualization module 220 executed by the processor(s) 230 may generate graphics, charts, or other visual representation of the workflow progress analytics as described with reference to block 914 of FIG. 9

In block 1014, the display of the workflow management computing device 102 may display via a graphical user interface, the one or more graphical representations of the workflow progress analytics. That is, the display 240 may display the graphical representations of the workflow progress analytics as described with reference to block 916 of FIG. 9.

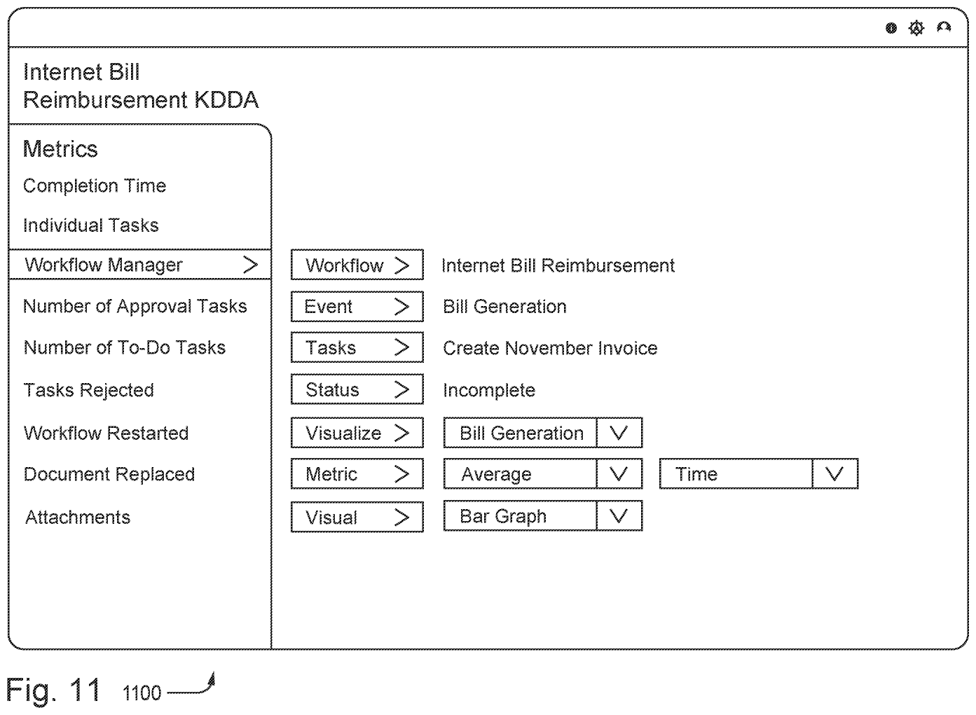

FIG. 11 shows a block diagram of a workflow progress analytics generation and visualization graphical user interface for a user computing. With reference to FIGS. 1-11, a workflow progress analytics generation GUI may be represented by generation GUI 1100, which provides functionality for generating and displaying workflow progress analytics. Various graphs, charts, models, or other visualizations may be generated based on the information in event data 314 and workflow data 222.

The generation GUI 1100 illustrates how metrics may be generated and visualized for “Internet Bill Reimbursement” workflow process. Many metrics may be generated and visualizations created by the processor(s) 330 executing instructions of the analytics module. For example, metrics on “bill generation” and other events, types, number of rejected events or tasks of an event, number of times a workflow process was restarted, number of documents modified during workflow process completion, and, specific documents required to complete events of a workflow process, and other metrics. The metrics available for visualization may depend on the type of event or workflow process for which the metrics are generated. In the generation UI 1100 shown, input fields in the form of txt boxes or dropdown menus are provided to enable users to select events for which workflow progress analytics should to be generated and visualized. The workflow progress analytics selected are indicated next to the “visualize” field and indicates that analytics related to “bill generation” are of interest to the user. The specific “metric” selected is “average” and the parameter is “parameter.” This indicates that the user would like the analytics module 318 to execute an analysis model to identify the mean of the completion time event attributes for “bill generation” events. The “visualization” selection field enables a user to select the type of graphical representation that they would like to represent the generated workflow progress analytics, in this case, the mean of the completion times for “bill generation events”. After submission, the result may be a bar graph showing the mean completion time of this type of event for different users or workflow processes. Various other options for each field are available and further fields may be added to increase the range of options. The user may generate customized reports of visualizations, by selecting those metrics that should be captured in the report.

The generated visualizations may be exported or converted by the processor(s) 330, which captures the GUI in a PDF, inserts the visualizations into a document file, or the like. Generated visualizations may also be forwarded to other users, by converting the visualizations into a file and attaching the file to a message to the other users or the workflow management computing device 102. This message may be generated via an application programing interface accessing an email program on the user computing device 104A. Similarly, the message may be generated within the workflow management system 100 and may be sent to a user computer, and appear within an inbox of the workflow application 310 of the user computing devices 104B-D or workflow management computing device 102. Using the report customization and visualization export functions, users 106A-B can share metrics and visualizations with interested and impacted parties.

The analytics module 318 may provide one or more UIs that enable functionality similar to that described with reference to FIG. 6. The analytics module 318 utilizes analytics modules, scripts, and algorithms to generate workflow progress analytics and corresponding graphical representations for users. Various UIs of the workflow application 310 and its component modules may provide additional visual elements that enable functionality for creating, viewing, editing, and otherwise managing workflow processes.

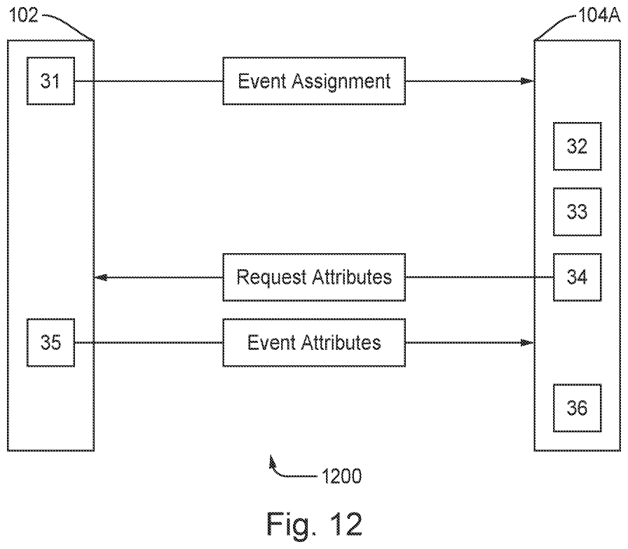

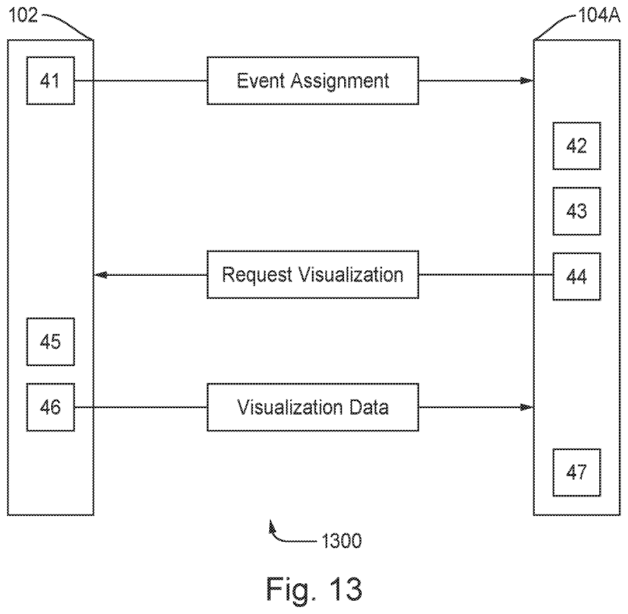

Referring now to FIGS. 12 and 13, there are shown call flow diagrams for different methods of generating visualizations of workflow progress analytics. With reference to FIGS. 1-13, the user computing device 104A may generate workflow progress analytics using event data 314 and may also use the workflow data 222 as provided by the workflow management computing device 102. Some embodiments include generation of workflow progress analytics by the user computing device 104A and other embodiments include generation by the workflow management computing device 102 for the user computing device 104A.

At blocks 31 and 41, an event assignment message is received from the workflow management computing device 102. The network communication interface 360 of the user computing device 104A may receive the message and pass it to the processor(s) 330. The event indicated in the event assignment message is then accepted by a user 106A, at blocks 32 and 42. This may proceed in a manner similar to that described with reference to steps 3 and 4 of FIG. 7. At blocks 33 and 43, the event indicated in the event assignment message may be begun and, or completed.

In the embodiment of method 1200, the user computing device may receive a request from a user to provide workflow progress analytics. At block 34, the analytics module 318 may receive the user request and compare it against event data 314 to determine if additional data is needed in order to complete the request. For example, requests related to events completed by the user 106A may be stored within the event data 314 and may not require additional information in order to generate workflow progress analytics. But, requests to compare the user's event completion patters against those of other users may require data stored in the workflow data 222. As such, the user computing device 104A may transmit an event attribute request message to the workflow management computing device.

In block 35, the workflow management computing device 102 receives the event attributes request message and checks the contents against the workflow data 222. If the requested data is stored within the workflow data 222, then the workflow management computing device retrieves the data, writes it to a file, attaches the file to an electronic message and transmits the electronic message to the user computing device 104A. Alternatively, for smaller amounts of data, the workflow management computing device may add the requested data directly to the electronic message.

In block 36, the user computing device receives the electronic message including the requested event attribute data either directly or in a file. The analytics module 318 reads this data and passes it as input to an analytics model to generate the requested workflow progress analytics. In some implementations the requested event attributes may be combined, appended, to or otherwise joined with information in the event data 222 to provide input for the analytics model.

In some instances, it may be advantageous to have the workflow management computing device 102 perform the generation of workflow progress analytics rather than the user computing device 104A. For example, if the bulk of the data needed lies in workflow data 222 and not event data 314, it may be more resource efficient to have workflow management computing device 102 perform the analysis. Similarly, if the volume of data requested in the event attribute request message is large, it may not be cost effective from a bandwidth utilization perspective, to transmit the data to the user computing device 104A. In embodiments of method 1300, the user computing device 104A transmits an event attribute request message at block 44, and workflow progress analytics are generated by the workflow management computing device 102. The event attribute request message may include the request for event attributes along with any desired metrics for which workflow progress analytics should be generated.

In block 45, the workflow management computing device reviews the event attributes request message received from the user computing device 104A. If the message requests that the workflow management computing device generate the workflow progress analytics, or if the requested data exceeds a volume threshold, the workflow management computing device 102 generates the workflow progress analytics using analytics generation module 218. The analytics generation module 218 may review the request for event attributes or a workflow progress analytic and may query the workflow data 222 to obtain inputs for one or more analytics models.

In block 46, the workflow management computing device may provide the workflow progress analytics along with nay requested visualization data to the user computing device 104A in a message or a file attached to the message. The user computing device 104A uses the received data to generate visualizations or graphical representations of the workflow progress analytics received from the workflow management computing device.

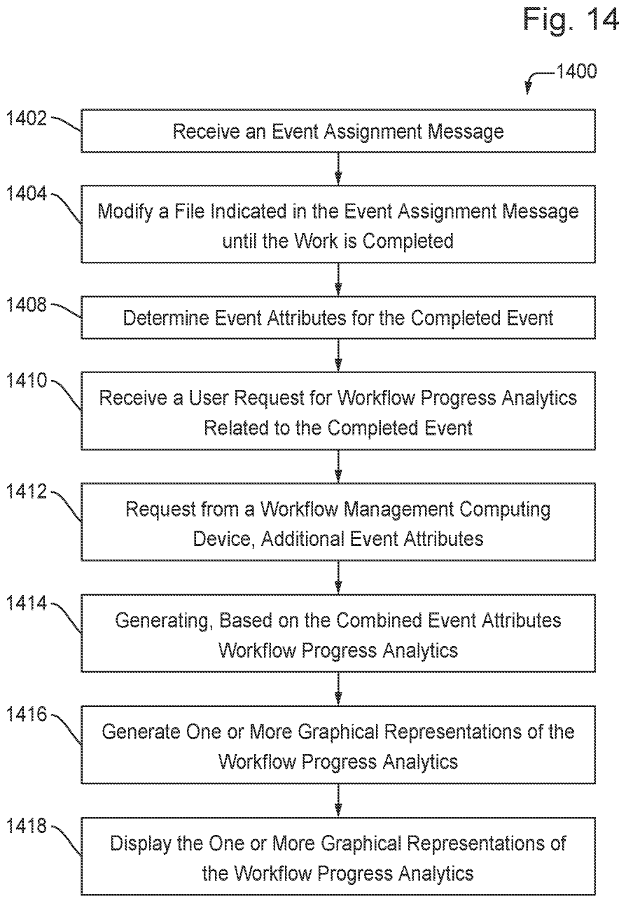

Referring now to FIG. 14, a method 1400 is shown for visualizing workflow progress analytics on a user computing device. With reference to FIGS. 1-14, the user computing device 104A, may execute various processor-executable instructions for generating and visualizing workflow progress analytics. These workflow progress analytics may be representative or related to events completed by the user 106A on the user computing device 104A.

In block 1402, the network communication interface may receive an event assignment message including at least one event of a workflow process, the event assignment message indicating work to be completed in order to complete the event. That is, the network communication interface 360 may receive an event assignment message that includes an event to which the user is assigned. The event assignment message may include an event identifier for the vent, one or more files or files to files associated with the vent, and completion requirements of the event. This information is stored by the event tracking module 312 in event data 314 for use by the workflow application 310 in tracking event completion.

In block 1404, the processor may modify a file indicated in the event assignment message until the work is completed. That is, the processor(s) 330 may access and modify or generate a file as directed by a user. The input/output interface 350 is used to receive user input regarding the file to modify or generate and the manner in which the modification should occur. In some implementations, the event may be determined to be complete when modification of the file ceases, e.g., the user closes the file. In some implementations, the event is determined to be complete when the file is created in a target location. In other implementations, the event is determined to be complete when a target field of the file is modified. In other implementations, the event is determined to be complete when the user selects a visual indicator of a UI indicating that the event is complete.

In block 1406, the processor may determine event attributes for the completed event. That is, the processor(s) 330 may execute event tracking module 312 to identify event characteristics such as timestamp for event start, timestamp for event completion, number of times file was modified, number of times the event was shared or passed to a different user, number of files accessed or modified in order to complete the vent, etc. In some implementations, event attributes may also be calculated using the analytics module 318. Calculated event attributes can include completion time, length of time the file was in use or being accessed, etc. Calculated event attributes may be specified in the event assignment message. Some or all determined event attributes may be transmitted back to the workflow management computing device 102 in an event completion message.

In block 1408, the input/output interface receives a user request for workflow progress analytics related to the completed event. That is, the input/output device 350 may receive user input associated with a UI field entry indicating that a workflow progress analytics generation has been request by a user. For example, the generation UI 1100 may receive a user request as indicated in text fields and drop down menu selections. The analytics module 318 may compare the request against stored event data 314 to determine if additional data is needed in order to complete the request. If data needed to complete the request is not present in the event data 314, the user computing device 104A will request the data from the workflow management computing device 102.

In block 410, the network communication interface may request from a workflow management computing device, additional event attributes. That is, the network communication interface 360 may transmit an event attributes request message including a request for the provision of event attributes from workflow data 222. The event attribute request message may include the event identifier for the completed event along with the specific event attributes or metrics that should be collected or generated. Event attributes retrieved from the workflow data 222 may be transmitted to the user computing device 104A in a message or as a file attached to the message.

In block 1412, the processor generates based on the combined event attributes, workflow progress analytics. That is, the analytics module 318 executed by processor(s) 330 may use the vent attributes provided by the workflow management computing device 102 and data from the event data 314 to generate workflow process analytics. This may be accomplished by applying the combined data as inputs to one or more analytics models. This may occur in a manner similar to that described with reference to block 912 of FIG. 9.

In block 1414, the processor generates one or more graphical representations of the workflow progress analytics for the workflow process. That is, the analytics module 318 executed by processor(s) 330 may use the generated workflow progress analytics to generate one or more visual representations of the analytics. This may occur in a manner similar to that described with reference to block 914 of FIG. 9.

In block 1416, the display displays via a graphical user interface on a display, the one or more graphical representations of the workflow progress analytics. That is, the display may output the generated visual representations of the workflow progress analytics via a UI. This may occur in a manner similar to that described with reference to block 916 of FIG. 9.

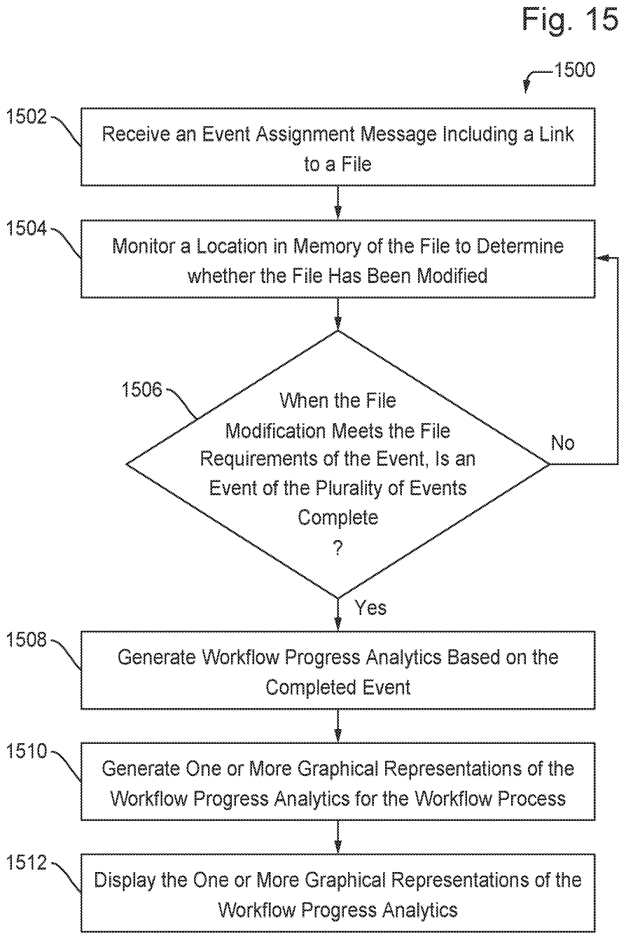

Referring to FIG. 15, there is shown a method 1500 for detecting event completion. With reference to FIGS. 1-15, a user computing device, e.g. user computing device 104A may monitor or track utilization or generation of files associated with assigned events to which a user 106A is assigned, in order to automatically detect event completion. For events that require the completion of several tasks in order for the event to be completed, the same techniques may be applied to auto detect completion of tasks associated with files.

In block 1502, the network communication interface of the user computing device may receive an event assignment message including a link to a file. That is, the network communication interface 360 may receive may receive an electronic message from the workflow management computing device 102 indicating an event assignment and including a link to a file or a location in memory at which a file should be created. The event may be stored in the event data 314 in association with the file location or link. In block 1504, the processor of the user computing device may monitor a location in memory of the file to determine whether the file has been modified. That is, event tracking module 312 executed by the processor(s) 330 of the user computing device 104A may monitor a location in memory or a file folder of a file structure in a manner substantially similar to that described with reference to that executed by the workflow management computing device and described with reference to block 1006 of FIG. 10.

In block 1506, the processor of the user computing device may determine whether the event is complete when the file modification meets the file requirements of the event. That is, the event tracking module 312 executed by processor(s) 330 may determine whether an event or tasks is complete based on whether the file has been modified or created. This may occur in a manner substantially similar to that described with reference to the workflow management computing device 102 in block 1008 of FIG. 10.

In block 1508, the processor may generate workflow progress analytics based on the completed event. That is, the analytics module 318 executed by processor(s) 330 may run scripts, code templates, code segments, for various models to generate workflow progress analytics related to the event, in a manner similar to that described with reference to the workflow management computing device 102 in block 912 of FIG. 9. This may include requesting, from the workflow management computing device 102 portions for the event data 222 including event attributes for one or more workflow processes.

In block 1510, the processor of the user computing device may generate one or more graphical representations of the workflow progress analytics for the workflow process. That is, the analytics module 318 executed by processor(s) 330 my generate one or more graphical representation of the workflow progress analytics in a manner substantially similar to that described with reference to the workflow management computing device 102 in block 914 of FIG. 9.

In block 1512, the display of the user computing device may display the one or more graphical representations of the workflow progress analytics. That is, the display 340 of the user computing device 104A, may output the one or more graphical representations of the workflow progress analytics in a manner substantially similar to that described with reference to the workflow management computing device 102 in block 916 of FIG. 9.

It is to be understood that the above description is intended to be illustrative, and not restrictive. Many other implementations are apparent upon reading and understanding the above description. The scope of the disclosure should, therefore, be determined with reference to the appended claims, along with the full scope of equivalents to which such claims are entitled.

In the above description, numerous details are set forth. It is apparent, however, that the disclosure may be practiced without these specific details. In some instances, structures and devices are shown in block diagram form, rather than in detail, in order to avoid obscuring the disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving”, “determining”, “identifying”, “updating”, “copying”, “publishing”, “selecting”, “utilizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems appears as set forth in the description below. In addition, the disclosure is not described with reference to any particular programming language. It is appreciated that a variety of programming languages may be used to implement the teachings of the disclosure as described herein.

The disclosure may be provided as a computer program product, or software, that may include a machine-readable medium having stored thereon instructions, which may be used to program a computer system (or other electronic devices) to perform a process according to the disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A workflow management computing device for workflow process analysis comprising:
a processor;
a display;
a network communication interface;
a memory in communication with the processor and having stored thereon, processor-executable instructions for causing the processor to perform operations comprising:
generating, in a data storage in the memory, a workflow process including a plurality of events;
assigning each of the plurality of events to one or more users of a user population;
transmitting, by the network communication interface of the workflow management computing device to computing devices of each of the one or more users, event assignment messages indicating an event to which the user is assigned;
receiving, by the network communication interface of the workflow management computing device, an event completion message from a computing device of a first user, indicating that an event assigned to the first user has been completed, wherein the event completion message includes event attributes for the completed event;
updating, in the data storage, the event attributes for the completed event associated with the received event completion message;
generating, based on the stored event attributes, workflow progress analytics;
generating one or more graphical representations of the workflow progress analytics for the workflow process; and
displaying, via a graphical user interface on the display of the workflow management computing device, the one or more graphical representations of the workflow progress analytics.

2. The computing device of claim 1, further including processor-executable code to implement operations comprising:
displaying, via the graphical user interface, a graphical representation of the workflow process including user assignments for each of the plurality of events.

3. The computing device of claim 1, wherein transmitting, to the computing devices of each of the one or more users, the event assignment messages indicating an event to which the user is assigned causes the computing device of the user to display, via a graphical user interface of the user's computing device, one or more of the plurality of events assigned to the user.

4. The computing device of claim 1, wherein the generated workflow progress analytics comprise analytics for a user to which an event of the workflow process is assigned, and wherein the workflow progress analytics for the user include one or more of a number of events assigned to the user, completion time for each event assigned to the user, and a number of electronic documents modified by the user during completion of each event assigned to the user.

5. The computing device of claim 1, wherein the generated workflow progress analytics comprise analytics for an event of the workflow process, and wherein the workflow progress analytics for the event include one or more of the completion time of the event, number of users assigned to the event, and electronic documents accessed in completion of the event.

6. The computing device of claim 1, wherein the generated workflow progress analytics comprise one or more of the completion time for the entire workflow process, an original estimated completion time for the workflow process, a workflow process manager, use of templates in completion of events of the workflow process, modification of electronic documents during completion of the workflow process, number of events that required user approval, number of events that required user action, number of users that have read-only permission for events of the workflow process, number of events requiring feedback, number of users assigned to feedback events, whether an electronic document was replaced during completion of the workflow process, addition of file attachments during completion of the workflow process, and whether there was use of a parallel workflow process.

7. The computing device of claim 1, further including processor-executable code to implement operations comprising:
receiving an event rejection message from a computing device of a second user, indicating that an event assigned to the second user has been rejected.

8. The computing device of claim 7, wherein the workflow progress analytics comprise which events were rejected, whether any rejected events were forwarded to other users.

9. A method for workflow process analysis comprising:
generating, in a data storage of a workflow management computing device, a workflow process including a plurality of events;
assigning each of the plurality of events to one or more users of a user population;
transmitting, by a network communication interface of the workflow management computing device to computing devices of each of the one or more users, event assignment messages indicating an event to which the user is assigned;
receiving, by the network communication interface of the workflow management computing device, an event completion message from a computing device of a first user, indicating that an event assigned to the first user has been completed, wherein the event completion message includes event attributes for the completed event;
updating, in the data storage, the event attributes for the completed event associated with the received event completion message;
generating, based on the stored event attributes, workflow progress analytics;
generating one or more graphical representations of the workflow progress analytics for the workflow process; and
displaying, via a graphical user interface on a display of the workflow management computing device, the one or more graphical representations of the workflow progress analytics.

10. The method of claim 9, further comprising:
displaying, via the graphical user interface, a graphical representation of the workflow process including user assignments for each of the plurality of events.

11. The method of claim 9, wherein transmitting, to the computing devices of each of the one or more users, the event assignment messages indicating an event to which the user is assigned causes the computing device of the user to display, via a graphical user interface of the user's computing device, one or more of the plurality of events assigned to the user.

12. The method of claim 9, wherein the generated workflow progress analytics comprise analytics for a user to which an event of the workflow process is assigned, and wherein the workflow progress analytics for the user include one or more of a number of events assigned to the user, completion time for each event assigned to the user, and a number of electronic documents modified by the user during completion of each event assigned to the user.

13. The method of claim 9, wherein the generated workflow progress analytics comprise analytics for an event of the workflow process, and wherein the workflow progress analytics for the event include one or more of the completion time of the event, number of users assigned to the event, and electronic documents accessed in completion of the event.

14. The method of claim 9, wherein the generated workflow progress analytics comprise one or more of the completion time for the entire workflow process, an original estimated completion time for the workflow process, a workflow process manager, use of templates in completion of events of the workflow process, modification of electronic documents during completion of the workflow process, number of events that required user approval, number of events that required user action, number of users that have read-only permission for events of the workflow process, number of events requiring feedback, number of users assigned to feedback events, whether an electronic document was replaced during completion of the workflow process, addition of file attachments during completion of the workflow process, and whether there was use of a parallel workflow process.

15. The method of claim 9, further comprising:
receiving an event rejection message from a computing device of a second user, indicating that an event assigned to the second user has been rejected.

16. The method of claim 15, wherein the workflow progress analytics comprise which events were rejected, whether any rejected events were forwarded to other users.

17. A computer-readable medium, coupled to a processor, the computer readable medium comprising processor-executable code to implement operations comprising:
generating, in a data storage of a workflow management computing device, a workflow process including a plurality of events;
assigning each of the plurality of events to one or more users of a user population;
transmitting, via a network communication interface of the workflow management computing device, to computing devices of each of the one or more users, event assignment messages indicating an event to which the user is assigned;
receiving, via the network communication interface, an event completion message from a computing device of a first user, indicating that an event assigned to the first user has been completed, wherein the event completion message includes event attributes for the completed event;
updating, in the data storage, the event attributes for the completed event associated with the received event completion message;
generating, based on the stored event attributes, workflow progress analytics;
generating one or more graphical representations of the workflow progress analytics for the workflow process; and
displaying, via a graphical user interface on a display of the workflow management computing device, the one or more graphical representations of the workflow progress analytics.

18. The computer-readable medium of claim 17, further including processor-executable code to implement operations comprising:
displaying, via the graphical user interface, a graphical representation of the workflow process including user assignments for each of the plurality of events.

19. The computer-readable medium of claim 17, wherein transmitting, to the computing devices of each of the one or more users, the event assignment messages indicating an event to which the user is assigned causes the computing device of the user to display, via a graphical user interface of the user's computing device, one or more of the plurality of events assigned to the user.

20. The computer-readable medium of claim 17, further including processor-executable code to implement operations comprising:
receiving an event rejection message from a computing device of a second user, indicating that an event assigned to the second user has been rejected.
